(19) United States
(12) Patent Application Publication
(10) Pub. No.: US 2017/0367031 A1
(43) Pub. Date: Dec. 21, 2017

(54) BASE STATION DEVICE, TERMINAL DEVICE, AND COMMUNICATION CONTROL METHOD

(71) Applicant: SHARP KABUSHIKI KAISHA, Sakai City, Osaka (JP)

(72) Inventors: Yoko KUGE, Sakai City (JP); Masafumi ARAMOTO, Sakai City (JP)

(73) Assignee: SHARP KABUSHIKI KAISHA, Sakai City, Osaka (JP)

(21) Appl. No.: 15/544,581

(22) PCT Filed: Jan. 18, 2016
(86) PCT No.: PCT/JP2016/051237

§ 371 Date: Jul. 19, 2017

(30) Foreign Application Priority Data
Jan. 20, 2015 (JP) 2015-008505

(51) Int. Cl. H04W 48/02; H04L 29/06; H04W 12/06; H04W 24/04

(52) U.S. Cl. CPC H04W 48/02; H04W 24/04; H04L 63/0876; H04W 12/06

(57) ABSTRACT

A location management device function is provided in an access network, and a base station identifies and authenticates a terminal device permitted to perform base station loopback communication on the basis of identification information on the terminal device received from the terminal device. With this configuration, provided is a communication control method and the like for the base station device that has lost connectivity to a core network, to permit only specific terminals to perform base station loopback communication.

### TECHNICAL FIELD

The present invention relates to a base station device, a terminal device, and a communication control method.

### BACKGROUND ART

The 3rd Generation Partnership Project (3GPP), which undertakes activities for standardizing recent mobile communication systems, is in the process of creating specifications for the Evolved Packet System (EPS), which realizes an all-IP architecture (see NPL 1). The EPS is a mobile communication system through which mobile network operators and the like provide mobile telephone services, and is structured including a core network called the Evolved Packet Core (EPC), an access network based on the Long Term Evolution (LTE) radio communication standard, and the like.

In the course of creating specifications for the EPS, the 3GPP has also been considering isolated E-UTRAN operation for public safety (IOPS) (NPL 2). For the IOPS, the 3GPP is considering functions of access networks (isolated E-UTRAN) and/or terminal devices to enable communication between the terminals connected to the access networks that have lost a connection to a core network (backhaul) due to disaster or the like. Note that the isolated E-UTRAN may be a known access network that is constituted of one or multiple base station devices and configured to connect to the core network in a normal state where no disaster or the like has occurred.

This configuration enables communication between adjacent terminals located in the service areas of base stations constituting the same access network, even in a state where a connection between any of the base stations and the core network is discontinued and/or a state where a restriction is needed for the connection.

### CITATION LIST

### Non Patent Literature

NPL 1: 3GPP TS23.401 Technical Specification Group Services and System Aspects, General Packet Radio Service (GPRS) enhancements for Evolved Universal Terrestrial Radio Access Network (E-UTRAN) access (Release 12)
NPL 2: 3GPP TS22.346 Technical Specification Group Services and System Aspects; Isolated E-UTRAN Operation for Public Safety; Stage 1 (Release 13)

### SUMMARY OF INVENTION

### Technical Problem

For the IOPS, the 3GPP is considering initiation of base station loopback data transfer service based on the IOPS upon transition from a normal state, in which the base station connects to the core network normally, to a state in which the base station has lost a connection to the core network or a state in which some restriction is imposed.

It is also assumed that public safety terminals, such as a police radio and a fire department radio, communicate in the IOPS.

Hence, a connection to the isolated E-UTRAN is not permitted for all terminals, and connection restriction or connection authentication is needed depending on terminals.

However, a core network has been responsible for a connection control function and authentication information management corresponding to a terminal or subscriber. For this reason, no means for approving a connection to the isolated E-UTRAN or no means for approving a service enabled with a connection to the isolated E-UTRAN, such as data communication, has not been disclosed. In light of the above circumstances, an object of the present invention is to provide a preferable means for a terminal to connect to a base station and/or an access network that is in a state where a connection to the core network is lost or a state where a restriction on a connection to the core network is needed.

### Solution to Problem

A base station device according to the present embodiment is configured to: transmit, to a terminal device, a notification message indicating that the base station device is in a first state where connectivity to a core network is lost and/or a second state where a restriction on connectivity to the core network is imposed; receive an attach request message from the terminal device; when the attach request message includes permission information, transmit an attach permission message to the terminal device as a response to the attach request message, the permission information being permission information indicating that communication based on an isolated E-UTRAN function is permitted, the isolated E-UTRAN function being a function of the base station device or a gateway transferring user data when the base station device is in the first state where connectivity to the core network is lost and/or the second state where the restriction on connectivity to the core network is imposed; and when the attach request message does not include the permission information, transmit an attach reject message to the terminal device as a response to the attach request message.

A terminal device according to the present embodiment is configured to: transmit an attach request message to a base station device; and receive an attach reject message that is a response to the attach request message and includes at least cause information indicating that establishing a connection to an isolated E-UTRAN is not permitted, the isolated E-UTRAN being an access network having the base station device in a first state where connectivity to a core network is lost and/or a second state where a restriction on connectivity to the core network is imposed.

A communication control method for a base station device according to the present embodiment includes the steps of: transmitting, to a terminal device, a notification message indicating that the base station device is in a first state where connectivity to a core network is lost and/or a second state where a restriction on connectivity to the core network is imposed; receiving an attach request message from the terminal device; when the attach request message includes permission information, transmitting an attach permission message to the terminal device as a response to the attach request message, the permission information being permission information indicating that communication based on an isolated E-UTRAN function is permitted, the isolated E-UTRAN function being a function of the base station device or a gateway transferring user data when the base station device is in the first state where connectivity to the core network is lost and/or the second state where a restriction on connectivity to the core network is imposed; and when the attach request message does not include the permission information, transmitting an attach reject message to the terminal device as a response to the attach request message.

A communication control method for a terminal device according to the present embodiment, includes the steps of: transmitting an attach request message to a base station device; and receiving an attach reject message that is a response to the attach request message and includes at least cause information indicating that establishing a connection to an isolated E-UTRAN is not permitted, the isolated E-UTRAN being an access network having the base station device in a first state where connectivity to a core network is lost and/or a second state where a restriction on connectivity to the core network is imposed.

### Advantageous Effects of Invention

According to the present invention, communication between terminal devices located within a service area of a base station device that has lost a normal connection to a core network can be implemented with communication via the base station device without involving the core network.

### BRIEF DESCRIPTION OF DRAWINGS

FIGS. 1A to 1C are diagrams illustrating an overview of a mobile communication system.

FIGS. 2A and 2B are diagrams illustrating a configuration of an IP mobile communication network and the like.

FIG. 3 is a diagram illustrating a functional configuration of an eNB.

FIGS. 4A to 4C are diagrams illustrating a configuration of a storage of the eNB.

FIGS. 5A and 5B are diagrams illustrating a functional configuration of an I-MME.

FIG. 6 is a diagram illustrating a state transition detection procedure.

FIG. 7 is a diagram illustrating a modified example of the state transition detection procedure.

FIG. 8 is a diagram illustrating an attach procedure.

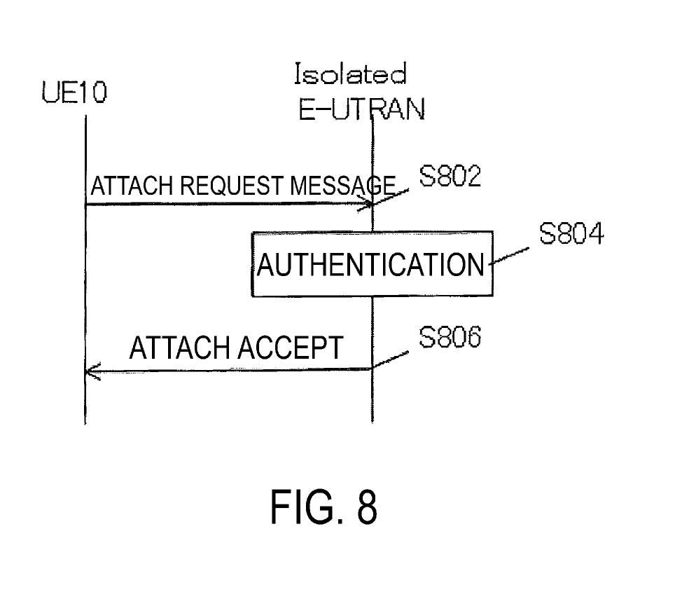

FIG. 9 is a diagram illustrating a tracking area update procedure.

FIG. 10 is a diagram illustrating a reject procedure.

### DESCRIPTION OF EMBODIMENTS

### 1. First Embodiment

Hereinafter, a radio communication technology according to an embodiment of the present invention will be described in detail with reference to the drawings.

### 1.1. System Overview

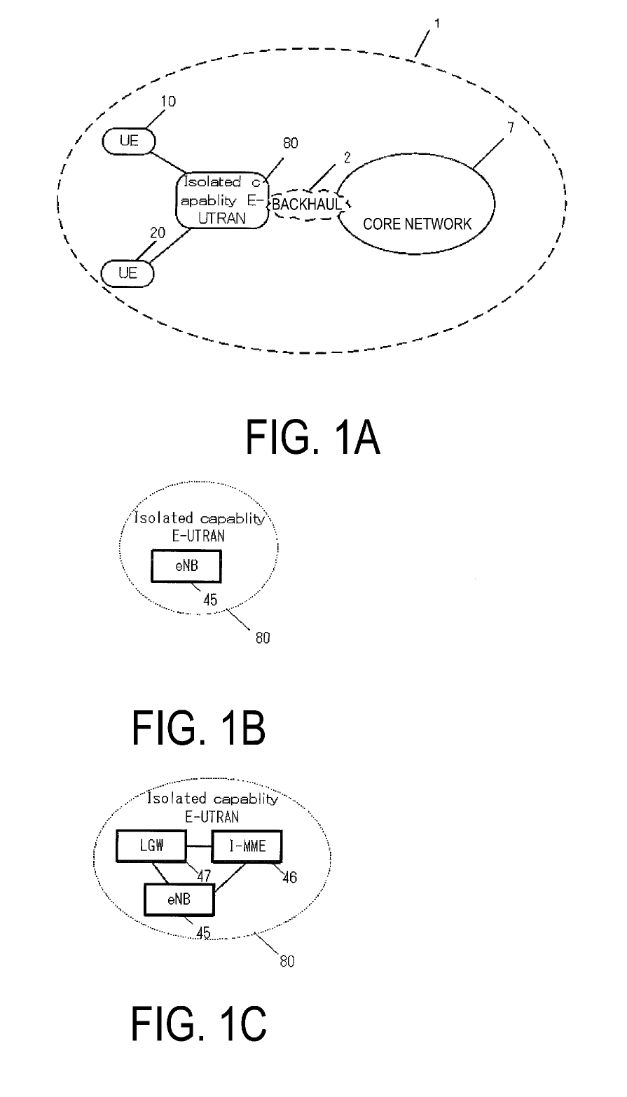

FIG. 1A is a diagram illustrating an overview of a mobile communication system according to the present embodiment. In a mobile communication system 1, one or more terminal devices are connected to an access network. For example, a terminal device UE 10 and a terminal device UE 20 are connected to the access network as illustrated in FIG. 1A. Furthermore, the access network can connect to a core network 7. As illustrated in FIG. 1A, the access network and the core network 7 can connect to each other with a backhaul 2 in the present embodiment. Here, the backhaul 2 may be a network providing connectivity between the access network and the core network 7 by using a communication means, such as the Internet.

The access network in the present embodiment may be an isolated capablity E-UTRAN 80.

Here, in the present embodiment, a state of the access network or a base station when the backhaul 2 continues to provide normal connectivity between the access network and the core network 7 is referred to as a normal state. In this case, the isolated capablity E-UTRAN 80 may be an access network performing a similar function to that of a known E-UTRAN.

In the present embodiment, a state of the access network or the base station where the backhaul 2 has completely lost connectivity or where a restriction on communication using the backhaul 2 is needed, is referred to as an isolated E-UTRAN state. In the isolated E-UTRAN state, the isolated E-UTRAN performs a communication control function with which the base station delivers, as an anchor device, user data transmitted from UE, to another UE.

Furthermore, in the present embodiment, a state of the access network or the base station where the backhaul 2 has completely lost connectivity is referred to as an isolated E-UTRAN state A, and a state of the access network or the base station where a restriction on communication using the backhaul 2 is needed, is referred to as an isolated E-UTRAN state B.

Here, the restriction on the communication using the backhaul 2 in the isolated E-UTRAN state B may be, for example, a restriction that permits only control signals. Alternatively, the restriction may be imposed on both control signals and user data on the basis of a user, an application, or the like. To be more precise, the isolated E-UTRAN state B may be a state where connectivity is established between the access network and the core network 7, but user data transmitted from and received by a terminal cannot be delivered between the access network and the core network 7 while control signals for performing communication control can be transmitted and received therebetween.

In the present embodiment, description is given of a communication control method to be used at the time of switching communication between the terminals from communication in the normal state via the core network 7 and/or a packet data network (PDN) to communication based on an isolated E-UTRAN function, upon a transition of the state of connectivity of the isolated capablity E-UTRAN 80 or the base station to the core network.

Note that in the present embodiment, the communication based on the isolated E-UTRAN function is performed in a communication method using the isolated capablity E-UTRAN 80 in the isolated E-UTRAN state (the isolated E-UTRAN state A and/or the isolated E-UTRAN state B) and/or the base station included in the isolated capablity E-UTRAN 80 in the isolated E-UTRAN state and refers to a communication control function based on base station or gateway loopback without involving the core network.

Hence, the isolated E-UTRAN function includes at least functions of a base station and/or a gateway for authenticating a terminal device and transferring user data in a state where the base station device is in the isolated E-UTRAN state.

The isolated E-UTRAN function may further include a function of carrying out a process or a procedure of the base station, the gateway, the terminal device and/or a location management device in the isolated E-UTRAN state, which will be described in the present embodiment.

Here, in the present embodiment, the UE 10 is a terminal permitted to perform communication based on the isolated E-UTRAN, and the UE 20 is a terminal not permitted to perform the communication. Alternatively, the UE 10 is a terminal device permitted to connect to the isolated E-UTRAN and/or to connect to and communicate with the isolated E-UTRAN. Furthermore, the UE 20 is the UE 10 is a terminal device not permitted to connect to the isolated E-UTRAN and/or to connect to and communicate with the isolated E-UTRAN.

The core network 7 refers to an IP mobile communication network run by a mobile operator. The core network 7 is connected to the PDN. The PDN is a packet data service network providing communication services to terminal devices connecting thereto and may be configured for each service.

The isolated capablity E-UTRAN 80 may be an access network capable of performing the isolated E-UTRAN function in accordance with the state of a connection to the core network 7 of the base station included in the network. More specifically, in the normal state, the isolated capablity E-UTRAN 80 may be a known E-UTRAN providing communication via the core network 7 and/or the PDN.

More specifically, the isolated capablity E-UTRAN 80 may be an E-UTRAN in a state where the isolated capablity E-UTRAN 80 or the base station is in the normal state and may be an access network performing the isolated E-UTRAN function in the isolated E-UTRAN state.

Alternatively, the isolated capablity E-UTRAN 80 may be an access network unable to provide communication via the core network 7 and/or the PDN. Thus, the isolated capablity E-UTRAN 80 may be an access network performing the isolated E-UTRAN function only in the isolated E-UTRAN state.

FIG. 1B is a configuration diagram of the isolated capablity E-UTRAN 80 that is an E-UTRAN in the normal state. As illustrated in FIG. 1B, the isolated capablity E-UTRAN 80 is configured to include at least one base station eNB 45. The eNB 45 is a radio base station in the LTE access system, and connects to the core network via the backhaul. Note that the E-UTRAN 80 may be configured to include one or multiple eNBs 45.

FIG. 1C is a configuration diagram of the isolated capablity E-UTRAN 80 in the isolated E-UTRAN state. In this state, the isolated capablity E-UTRAN 80 is constituted of the eNB 45, an isolated E-UTRAN MME (I-MME) 46, and a local GW (LGW) 47.

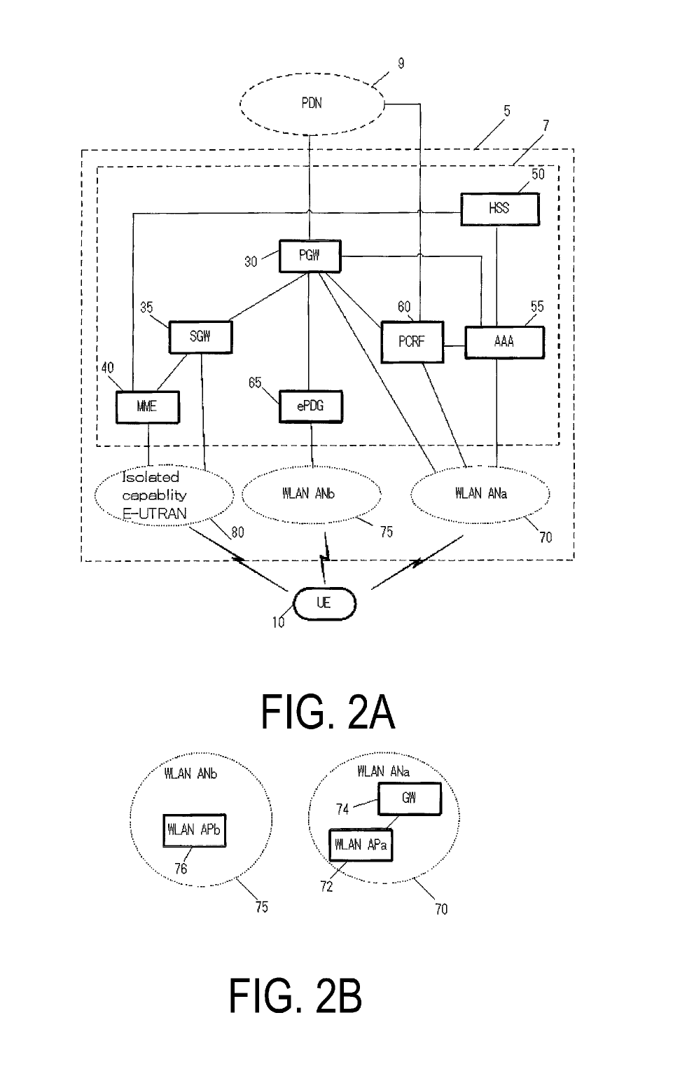

The I-MME 46 is a device that is included in the isolated E-UTRAN and has part of the function of the mobility management entity (MME) combined with the eNB 45. Although details will be described with reference to FIGS. 2A and 2B, location management of terminal devices is performed with an MME included in the core network 7 in the normal state. Note that the I-MME 46 may be a management device that performs location management of terminals only in the isolated E-UTRAN state.

In the present embodiment, it is assumed that the isolated capablity E-UTRAN 80 includes one I-MME 46, but the isolated capablity E-UTRAN 80 may be configured to include multiple I-MMEs 46. Moreover, the I-MME 46 is described as a separate device from the eNB 45 in FIG. 2C, but the I-MME 46 and the eNB 45 may be configured as a monolithic device. For example, the I-MME 46 may be configured to be included in the eNB 45.

The LGW 47 is a gateway device included in the isolated E-UTRAN. Here, a gateway function may be a user data relay function to deliver communication data between terminals within each access network. Note that the LGW 47 may be a management device that performs the gateway function only in the isolated E-UTRAN state. Note that the LGW 47 and the eNB 45 may be configured as a monolithic device. For example, the LGW 47 may be configured to be included in the eNB 45. Furthermore, the LGW 47, the I-MME 46, and the eNB 45 may be configured as a monolithic device.

Thus, the LGW 47 may be a relay device that is in combination with the eNB 45 and transfers user data without involving any communication operator network. Alternatively, the LGW 47 may be a relay device that transfers user data independently from the eNB 45. The LGW 47 may be used by the base station in the isolated E-UTRAN state as a gateway for establishing a PDN connection at the time of performing communication based on the isolated E-UTRAN function.

The eNB 45 is a base station having the isolated E-UTRAN function. The eNB 45 can change the access network to which the eNB 45 belongs, to the E-UTRAN or the isolated E-UTRAN, upon state transition of the eNB 45 or notification from the core network 7.

Next, an example of a configuration of the core network will be described. The core network is constituted of a home subscriber server (HSS), an authentication, authorization, accounting (AAA), a policy and charging rules function (PCRF), a packet data network gateway (PGW), an enhanced packet data gateway (ePDG), a serving gateway (SGW), and a mobility management entity (MME). These devices may be provided for each core network.

FIGS. 2A and 2B are diagrams illustrating the IP mobile communication network. In the present embodiment, description will be given mainly of an example in which the core network 7 is constituted of an HSS 50, an AAA 55, a PCRF 60, a PGW 30, an ePDG 65, an SGW 35, and an MME 40, as illustrated in FIGS. 2A and 2B.

The core network 7 can connect to multiple access networks (isolated capablity E-UTRAN 80, a WLAN ANb 75, and a WLAN ANa 70).

The radio access network may be configured to connect to multiple separate access networks or may be configured to connect to any one of the access networks. Furthermore, the UE 10 and the UE 20 can wirelessly connect to the radio access networks.

Furthermore, the WLAN access network b (WLAN ANb 75), which connects to the core network via the ePDG 65, and the WLAN access network a (WLAN ANa 75), which connects to the PGW 30, the PCRF 60, and the AAA 55, can be configured as the access networks that can be connected in the WLAN access system.

Note that each device has the same configuration as the conventional devices in mobile communication systems using EPS, and thus detailed descriptions thereof will be omitted. Each device will be described briefly hereinafter.

The PGW 30 is a relay device that is connected to a PDN 9, the SGW 35, the ePDG 65, the WLAN ANa 70, the PCRF 60, and the AAA 55 and transfers user data, as a gateway device between the PDN 9 and the core network 7.

The SGW 35 is a relay device that is connected to the PGW 30, the MME 40, and the LTE AN 80 and transfers user data, as a gateway device between the core network 7 and the LTE AN 80.

The MME 40 is an access control device that is connected to the SGW 35, the LTE AN 80, and the HSS 50 and performs location information management and access control for the UE 10 via the LTE AN 80. The core network 7 may be configured to include multiple location management devices. For example, an MME_C may be configured as a different location management device from the MME 40 in the core network 7. As with the MME 40, the MME_C may be connected to the SG 35, the LTE AN 80, and the HSS 50. This configuration allows the MME_C and the MME 40 to transmit and receive contexts of the UE 10.

The HSS 50 is a managing node that is connected to the MME 40 and the AAA 55 and manages subscriber information. The subscriber information of the HSS 50 is referred to during the access control by the MME 40, for example.

The AAA 55 is connected to the PGW 30, the HSS 50, the PCRF 60, and the WLAN ANa 70 and performs access control for the UE 10 connected thereto via the WLAN ANa 70.

The PCRF 60 is connected to the PGW 30, the WLAN ANa 75, the AAA 55, and the PDN 9 and manages QoS for data delivery. For example, the PCRF 60 manages QoS of a communication path between the UE 10 and the PDN 9.

The ePDG 65 is connected to the PGW 30 and the WLAN ANb 75 and delivers user data, as a gateway device between the core network 7 and the WLAN ANb 75.

As illustrated in FIG. 2B, each radio access network includes devices to which the UE 10 is actually connected (for example, a base station device and an access point device), and the like. Possible devices used in these connections include devices adapted to the radio access networks.

Having been described with reference to FIG. 1B and FIG. 1C, the details of the isolated capablity E-UTRAN 80 are omitted.

The WLAN ANa 70 is configured to include a WLAN APa 72 and a gateway (GW) 74. The WLAN APa 72 is a radio base station to which the UE 10 connects in a WLAN access system trusted by the operator running the core network 7, and the WLAN ANa 70 may be configured to include one or multiple radio base stations. The GW 74 is a gateway device between the core network 7 and the WLAN ANa 70. The WLAN APa 72 and the GW 74 may be configured as a monolithic device.

Additionally, the WLAN ANb 75 is configured to include a WLAN APb 76. The WLAN APb 76 is a radio base station to which the UE 10 connects in a WLAN access system having no trusting relationship established with the operator running the core network 7, and the WLAN ANb 75 may be configured to include one or multiple radio base stations.

In this manner, the WLAN ANb 75 is connected to the core network 7 via the ePDG 65 serving as a gateway, which is a device included in the core network 7. The ePDG 65 has a security function for ensuring security.

Note that, herein, the UE 10 and the UE 20 being connected to respective radio access networks refers to the UE 10 and the UE 20 being connected to base station devices, access points, or the like included in the respective radio access networks, and data, signals, and the like being transmitted and received also pass through the base station devices, the access points, or the like.

### 1.2. Device Configurations

Next, the configuration of each device will be described briefly with reference to the drawings.

### 1.2.1. eNB Configuration

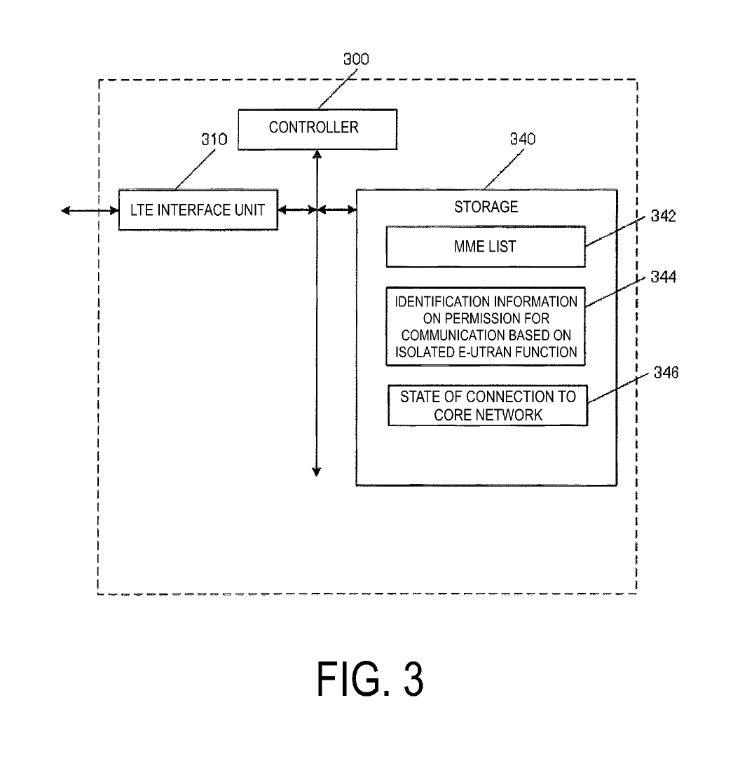

FIG. 3 illustrates a configuration of the eNB 45. As illustrated in FIG. 3, the eNB 45 is constituted of an LTE interface unit 310, a controller 300, and a storage 340. The LTE interface unit 310 and the storage 340 are connected to the controller 300 via a bus.

The controller 300 is a function unit for controlling the eNB 45. The controller 300 reads out various programs stored in the storage 340, and execute the programs to implement various processes.

The LTE interface unit 310 is a function unit for the eNB 45 to connect to the I-MME 46, the LGW 47, the MME 40, and/or the SGW 35.

The storage 340 is a function unit for storing programs, data, and the like necessary for operations of the eNB 45. The storage 340 is constituted, for example, of a semiconductor memory, a hard disk drive (HDD), or the like.

As illustrated in FIG. 3, the storage 340 stores an MME list 342, identification information 344 on permission for communication based on the isolated E-UTRAN function, and a state 346 of connection to the core network.

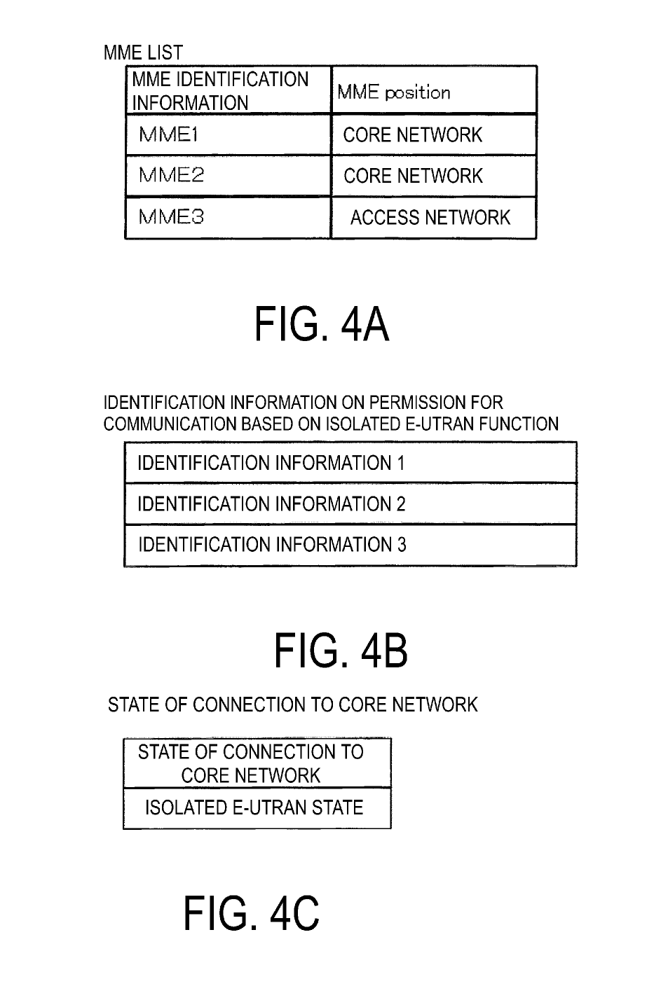

FIGS. 4A to 4C illustrate an example of information elements included in the storage 340. FIG. 4A illustrates an example of information stored in the MME list. The MME list is a list of MMEs to which the eNB 45 can connect or that the eNB 45 manages. As illustrated in FIG. 4A, the MME list may be information associating MME identification information and the network in which the corresponding MME is located.

The MME identification information may be, for example, a globally unique MME ID (GUMMEI) or an MME ID.

The network in which the MME is located is for identifying the network in which the MME is located and may store “core network” or “access network” as illustrated in FIG. 4A.

The network in which the MME is located may be information identifying the MME as the MME 40 included in the core network 7 or the I-MME 46 included in the isolated capablity E-UTRAN.

Note that the MME list may store multiple I-MMEs included in the access network. The MME included in the core network and the MME included in the access network may be managed with separate contexts.

FIG. 4B illustrates an example of identification information on permission for communication based on the isolated E-UTRAN function. As illustrated in FIG. 4B, the eNB 45 creates a list of pieces of identification information in order to identify terminal devices or users permitted to perform communication based on the isolated E-UTRAN, and stores the list. In the example in FIG. 4B, the eNB 45 can determine the UEs or the users identified by identification information 1, identification information 2, and identification information 3, as terminals based on the isolated E-UTRAN.

More specifically, the identification information may be a mobile country code (MCC: country code) or a mobile network code (MNC: operator code) included in an international mobile subscriber identity (IMSI) or a globally unique temporary identity (GUTI), or a type allocation code (TAC: identification information on manufacturer and/or model) included in an international mobile equipment identity (IMEI). Alternatively, the identification information may be the MME group ID or the MME code included in the GUTI. The identification information may be the IMSI, the GUTI, or the IMEI. The eNB 45 may store one or multiple pieces of identification information described above.

In other words, the eNB 45 in the isolated E-UTRAN state identifies, on the basis of the identification information, whether the UE is permitted to perform communication based on the isolated E-UTRAN.

FIG. 4C illustrates the state 346 of connection of the eNB 45 or the access network including the eNB 45 to the core network. The state 346 of the connection to the core network may store normal state or isolated E-UTRAN state. Alternatively, the state 346 may include identification information identifying the isolated E-UTRAN state A or the isolated E-UTRAN state B.

### 1.2.2. Configuration of I-MME

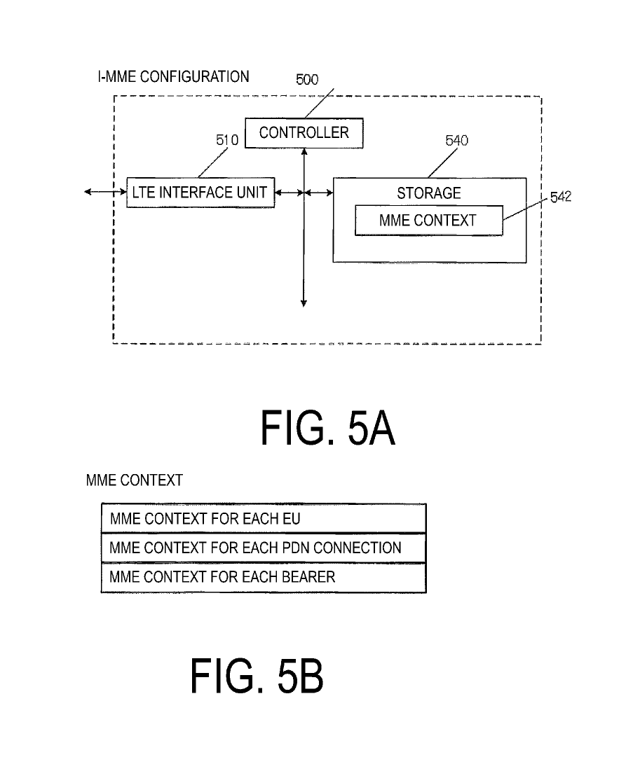

Next, description will be given of a configuration of the I-MME 46 included in the isolated capablity E-UTRAN 80. FIG. 5A illustrates the configuration of the I-MME 46. As illustrated in FIG. 5A, the I-MME 46 is constituted of an LTE interface unit 510, a controller 500, and a storage 540. The LTE interface unit 510 and the storage 540 are connected to the controller 500 via a bus.

The controller 500 is a function unit for controlling the I-MME 46. The controller 500 reads out various programs stored in the storage 540, and executes the programs to implement various processes.

The LTE interface unit 510 is a function unit for the I-MME 46 to connect to the eNB 45, the LGW 47, and/or the MME 40.

The storage 540 is a function unit for storing programs, data, and the like necessary for operations of the I-MME 46. The storage 340 is constituted, for example, of a semiconductor memory, a hard disk drive (HDD), or the like.

As illustrated in FIG. 5A, the storage 540 stores at least an MME context 524.

FIG. 5B illustrates information elements stored in the MME context. As illustrated in FIG. 5B, the MME context 542 stores an MME context for each UE, an MME context for each PDN connection, and an MME context for each bearer. The MME context 442 may be synchronized with part of the MME context stored in the MME 40.

More specifically, the MME context stored for each UE may include an IMSI, an MSISDN, a GUTI, an ME Identity, a Tracking Area List, a TAI of last TAU, a CSG ID, a CSG membership, an Access mode, a UE Radio Access Capability, a UE Network Capability, a UE Specific DRX Parameters, a Selected NAS Algorithm, an eKSI, a K_ASME, a NAS Keys and COUNT, an Access Restriction, an ODB for PS parameters, an APN-OI Replacement, a CSG Subscription Data, a LIPA Allowed, and an MPS CS priority.

The IMSI is users' permanent identity. This IMSI may be the same as the IMSI stored in the MME 40 and the HSS 50.

The MSISDN indicates the telephone number of UE. This MSISDN may be the same as the MSISDN stored in the MME 40.

The globally unique temporary identity (GUTI) is temporary UE identification information. The GUTI is constituted of MME identification information (globally unique MME identifier (GUMMEI)) and UE identification information in a specific MME (M-TMSI). This GUMMEI may be different from the GUMMEI in the MME 40. When the I-MME 46 and the MME 40 are associated with each other, this GUMMEI may be the same as the GUMMEI in the MME 40.

The ME Identity is the ID of the UE and may be, for example, IMEI/IMISV. The ME Identity, such as IMEI or IMISV, may be the same as the ME identity stored in the MME 40.

The Tracking Area List is a list of pieces of identification information on tracking areas allocated to the UE. In other words, the UE can use the tracking areas included in this list.

The TAI of last TAU is tracking area identification information registered in the most recent tracking area update procedure (TAU).

The CSG ID is the most recent identification information on a closed subscriber group (CSG) in which the UE is registered. This CSG ID may be the same as the CSG ID stored in the MME 40.

The CSG membership is the most recent member information on the CSG of the UE. The CSG membership indicates whether the UE is a CSG member.

The Access mode is an access mode of a cell identified by the ECGI and may be identification information indicating that the ECGI is hybrid for permitting access to both a UE in the CSG and a UE not in the CSG.

The UE Radio Access Capability is identification information indicating the radio access capabilities of the UE.

The UE Network Capability includes security algorithms and key derivation functions supported by the UE.

The UE Specific DRX Parameters are parameters used for determining the discontinuous reception (DRX) cycle length of the UE. Here, the DRX is a function of switching the state of the UE to a low-power-consumption mode when no communication is performed for a certain time period, in order to reduce the power consumption of the battery of the UE as much as possible.

The Selected NAS Algorithm is a selected non-access stream (NAS) security algorithm.

The eKSI is a set of keys indicating the K_ASME. The eKSI may indicate whether to use the security keys acquired from UTRAN or E-UTRAN security authentication.

The K_ASME is a key for E-UTRAN key hierarchy and is generated on the basis of a cipher key (CK) and an integrity key (IK).

The NAS keys and COUNT is constituted of a key K_NASint, a key K_NASenc, and a NAS COUNT parameter. The key K_NASint is a key for encryption between the UE and the MME, and the key K_NASenc is a key for ensuring security between the UE and the MME. The NAS COUNT is a count counted when a new key with which security between the UE and the MME has been established is configured.

The Access Restriction is access restriction registration information.

The ODB for PS parameters indicates the status of the operator determined barring (ODB). Here, the ODB is access regulations determined by the network operator (operator).

The APN-OI Replacement is a domain name to replace an APN when constructing a PGW FQDN upon which to perform a DNS resolution. The domain name as an alias is adapted to all APNs.

The CSG subscription data is associated lists of CSG IDs for the visiting PLMN (VPLMN) and equivalent PLMNs for the visiting PLMN. Each CSG ID may be associated with an expiration date indicating the point in time when the subscription to the CSG ID expires, or an absent expiration date indicating unlimited subscription. The CSG ID may be used for a specific PDN connection via the LIPA.

The LIPA Allowed indicates whether the UE is allowed to use the LIPA in this PLMN.

The Subscribed Periodic RAU/TAU Timer is a timer used to start regular routing area update (RAU) and/or tracking area update (TAU).

The MPS CS priority indicates that the UE is registered to eMLPP or 1×RTT priority service in the CS domain.

The MME context for each PDN connection may include an APN in Use, a PDN Type, an IP Address, an EPS PDN Charging Characteristics, an APN-OI Replacement, a SIPTO permissions, a Local Home Network ID, a LIPA permissions, an LGW Address in Use (control information), a Presence Reporting Area Action, an EPS subscribed QoS profile, and a Default bearer.

The APN in Use indicates the most-recently used APN. This APN is constituted of APN network identification information and default operator identification information.

The PDN Type indicates the type of an IP address. For example, the PDN Type indicates IPv4, IPv6, or IPv4v6.

The IP Address indicates an IPv4 address or an IPv6 prefix. Note that the IP Address may store both an IPv4 and an IPv6 prefix.

The EPS PDN Charging Characteristics indicate charging characteristics of the PDN connection. The EPS PDN Charging Characteristics may indicate, for example, normal, prepaid, flat rate, or hot billing.

The APN-OI Replacement is a domain name as an alias of the APN and has the same role as the APN-OI Replacement registered for each UE. Note that this APN-OI Replacement is given higher priority than the APN-OI Replacement for each UE.

The SIPTO permissions indicate permission information for selected IP traffic offload (SIPTO) of the traffic with this APN. Specifically, the SIPTO permissions identify that the traffic is prohibited for SIPTO, allowed for SIPTO excluding SIPTO at the local network, allowed for SIPTO at the network including the local network, or allowed for SIPTO at the local network only.

The Local Home Network ID indicates identification information on the home network to which the base station belongs when the SIPTO at the local network (SIPTO@LN) is enabled for this PDN connection.

The LIPA permissions are identification information indicating whether this PDN can be accessed via the LIPA. Specifically, the LIPA permissions may be LIPA-prohibited not permitting LIPA, LIPA-only permitting LIPA only, or LIPA-conditional permitting LIPA depending on conditions.

The LGW Address in Use (control information) indicates the most recent IP address allocated for the LGW. This address is used at the time of transmitting a control signal.

The Presence Reporting Area Action indicates that a notification of a change of UE presence in Presence Reporting Area is needed. This information element separately denotes Presence Reporting Area identification information and the elements included in the Presence Reporting Area.

The EPS subscribed QoS profile indicates a bearer-level QoS parameter for the default bearer.

The Default bearer is EPS Bearer identification information for identifying the default bearer in the PDN connection.

The MME context for each bearer may include EPS Bearer ID, TI, LGW IP address for U-plane, LGW TEID for U-plane, EPS bearer QoS, and TFT.

The EPS Bearer ID is unique identification information identifying an EPS bearer for UE accessing via the E-UTRAN.

The TI is an abbreviation for Transaction Identifier and is identification information identifying a bidirectional message flow (Transaction).

The LGW TEID for U-plane is the TEID of the LGW for user data transmission via the interface between the eNB 45 and the LGW.

The LGW IP address for U-plane is the IP address of the LGW for user data transmission via the interface between the eNB 45 and the LGW.

The EPS bearer QoS is constituted of a QoS class identifier (QCI) and allocation and retention priority (ARP). The QCI indicates the class to which the QoS belongs. The QoS is classified into classes depending on whether the presence or absence of band control, delay allowable time, packet loss rate, or the like. The QCI includes information indicating priority. The ARP is information indicating priority regarding retention of the bearer.

The TFT is an abbreviation of Traffic Flow Template and indicates all packet filters associated with the EPS bearer.

### 1.3. Description of Processing

In the present embodiment, description will be given of a process in which, in a state where the UE 10 has completed an attach procedure via the isolated capable E-UTRAN 80 in the normal state where connectivity to the core network is maintained and has established a PDN connection, the UE 10 detects a state transition to the isolated E-UTRAN state of the access network and, upon detection, performs an attach procedure and/or a tracking area update (TAU) procedure for the isolated E-UTRAN.

### 1.3.1. State Transition Detection Method

### 1.3.1.1. State Transition Detection Method

First, description will be given of a state transition detection method based on a configuration in which the UE 10 receives a notification message from the core network.

In the present embodiment, the isolated E-UTRAN state A or the isolated E-UTRAN state may be identified.

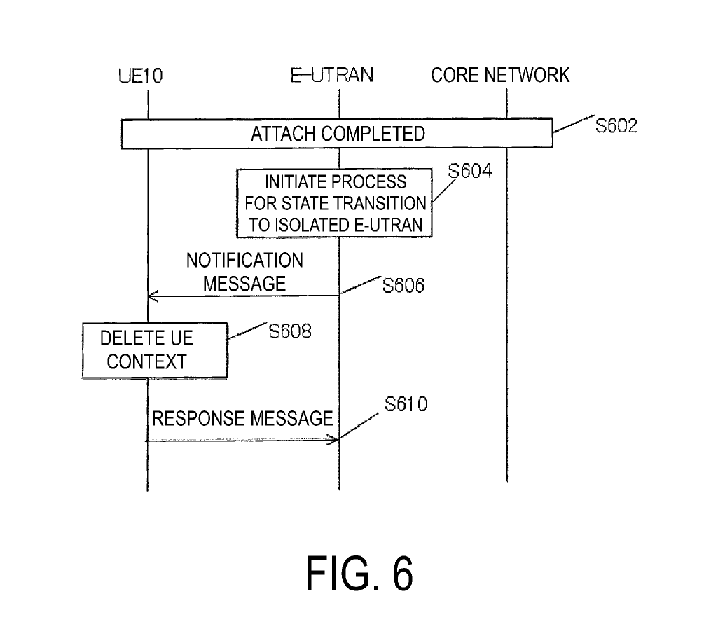

FIG. 6 illustrates an example of a procedure for state transition detection by the UE 10. As illustrated in FIG. 6, in the initial state, the UE 10 has established a PDN connection with the core network 7 including the MME 40, via the isolated capability E-UTRAN 80 (E-UTRAN) in the normal state (S602). In other words, the UE 10 has completed the attach procedure.

Note that such a PDN connection established in the initial state may be a PDN connection established between the UE 10 and the PGW 30 included in the core network.

In this case, the isolated capability E-UTRAN 80 transmits, to the core network 7, user data transmitted from the UE 10 and transmits, to the UE 10, user data addressed to the UE 10 and transmitted from the core network 7. In the normal state, the isolated capablity E-UTRAN 80 may perform such a transfer function.

The storage of each of the devices in the core network 7 may store, in the context, identification information that is allocated only to a terminal permitted to perform communication based on the isolated E-UTRAN and is included in a control message included in the attach procedure in the initial state and transmitted from the UE 10, as identification information of the UE 10.

More specifically, for example, the UE 10 may transmit, to the MME 40 included in the core network 7, an attach request message including an IMSI, an IMEI, or a GUTI allocated to the terminal permitted to perform communication based on the isolated E-UTRAN function, and the MME 40 may store the IMSI, the IMEI, or the GUTI included in the message, as identification information on the UE 10.

Furthermore, the MME 40 may distinguish between the MCC, the MNC, the TAC, the MME Group ID, and/or the MME code of the terminal not permitted to perform communication based on the isolated E-UTRAN function and the MCC and the MNC, the TAC, the MME group ID, and/or the MME code allocated to the terminal permitted to perform communication based on the isolated E-UTRAN function, for authenticating the UE 10.

In other words, in the present embodiment, the MME 40 may store the UE 10 permitted to perform communication based on the isolated E-UTRAN function and the UE 20 not permitted to perform communication based on the isolated E-UTRAN function in a distinguished manner, for authentication. In other words, the MME 40 can identify multiple MMCs, MNCs, TACs, MMME Group IDs, and/or the MME codes.

Alternatively, the UE 10 may store in advance the IMSI, the IMEI, or the GUTI allocated to the terminal permitted to perform communication based on the isolated E-UTRAN function and the IMSI, the IMEI, or the GUTI not permitted to perform communication based on the isolated E-UTRAN function and select identification information on the UE 10 to be used for the attach procedure, on the basis of the state of the isolated capablity E-UTRAN 80.

The UE 20 may transmit an attach request to the core network using the IMSI, the GUTI, or the IMEI not permitted to perform communication based on the isolated E-UTRAN function.

Note that the E-UTRAN may be the isolated capablity E-UTRAN 80 or the eNB 45 included in the isolated capablity E-UTRAN 80.

The isolated capablity E-UTRAN 80 may synchronize some pieces of information included in the MME contexts regarding the UE 10 in the storages of the MME 40 and the I-MME 46, in the attach procedure in the initial state. Specifically, the I-MME 46 may acquire part of the MME context from the MME 40.

The I-MME 46 may acquire some pieces of information in the MME context from the MME 40 on the basis of the fact that the UE 10 has been permitted to perform communication based on the isolated E-UTRAN or permission information indicating the permission.

Furthermore, the MME 40 does not need to synchronize the MME context regarding the UE 20 with that of the I-MME 46, on the basis of the fact that the UE 20 has not been permitted to perform communication based on the isolated E-UTRAN function.

In other words, the isolated capablity E-UTRAN 80 including the I-MME 46 may store some pieces of information in the MME context regarding the terminal permitted to perform communication based on the isolated E-UTRAN function and does not need to store the MME context regarding the terminal not permitted to perform communication based on the isolated E-UTRAN function.

Here, some pieces of information in the MME context may include an IMSI, a GUTI, an MSISDN, an ME Identity, a Tracking Area List, a TAI of last TAU, a CSG ID, a CSG membership, an Access Mode, UE Specific DRX Parameters, and LIPA allowed.

Alternatively, some pieces of information in the MME context may include the MCC or the MNC included in the IMSI or the GUTI, the TAC included in the IMEI (ME Identity), or the MME Group ID or the MME code included in the GUTI.

The isolated capablity E-UTRAN 80 may manage in advance identification information for identifying the UE permitted to establish a connection upon transition to the isolated E-UTRAN state. Furthermore, the isolated capablity E-UTRAN 80 may hold permission information indicating that the UE has been permitted to perform communication based on the isolated E-UTRAN function and permit a connection in accordance with the permission information. The isolated E-UTRAN 80 may reject a connection by any UE for which the isolated E-UTRAN 80 does not hold permission information.

Here, the permission information indicating that the UE has been permitted to perform communication based on the isolated E-UTRAN function may be information notified the isolated capablity E-UTRAN 80 by the UE 10.

The UE 10 may make the notification of permission information with the permission information included in a control message to be transmitted to the eNB 45 in the attach procedure. Here, the control message from the UE to the eNB 45 in the attach procedure may be an attach request message.

Alternatively, the permission information indicating that the UE 10 has been permitted to perform communication based on the isolated E-UTRAN function may be information notified the isolated capablity E-UTRAN 80 by the MME 40.

Specifically, the MME 40 may generate communication permission on the basis of the fact that the identification information on the UE 10 is identification information identifying a terminal permitted to perform communication based on the isolated E-UTRAN function and notify the isolated capablity E-UTRAN 80 and the I-MME 46 of the communication permission.

Alternatively, the UE 10 may notify the MME 40 of the permission information through a control signal transmitted from the UE 10 to the MME 40 in the attach procedure, such as an attach request message, and the MME 40 may notify the isolated capablity E-UTRAN 80 of the permission information in response to the reception of the permission information.

Alternatively, the HSS 50 may store in advance permission information in association with subscriber information on the UE 10 and notify the MME 40 of the permission information in the attach procedure initiated by the UE 10, and the MME 40 may notify the eNB 45 of the permission information in response to the reception of the permission information.

Synchronization between the contexts of the MME 40 and the I-MME 46 may be performed using a control message included in the attach procedure or performed using an independent message different from messages in the attach procedure.

The MME 40 may transfer, to the I-MME 46, management information on the UE 10 necessary for communication based on the isolated E-UTRAN function.

The management information on the UE 10 necessary for communication based on the isolated E-UTRAN function may be information in the MME context stored in the storage of the I-MME 46.

This configuration allows the isolated capablity E-UTRAN 80 including the I-MME 46 to store the UE 10 permitted to perform communication based on the isolated E-UTRAN function since the time of being in the normal state.

The isolated capablity E-UTRAN 80 initiates a process for a state transition to the isolated E-UTRAN state, in which connectivity to the backhaul 2 has been lost or a restriction on communication via the backhaul 2 is needed (S604).

Here, the isolated E-UTRAN state indicates a state in which connectivity from the eNB 45 to the core network has been physically lost due to, for example, a disaster, or a state in which a mobile eNB (normadic eNB) changes the serving LTE access network due to move and the new serving LTE access network does not have a connection to the core network. Alternatively, the isolated E-UTRAN state indicates a state in which connectivity from the eNB 45 to the core network has been lost or a restriction is needed, due to various other factors.

The initiation trigger for the state transition process may be a loss of connectivity of the interface (S1-U) between the eNB 45 and the SGW 35, for example.

Alternatively, the initiation trigger for the state transition process may be a loss of connectivity of the interface (S1-MME) between the eNB 45 and the MME 40. The initiation trigger may be both of the above.

Upon detection of the trigger, the eNB 45 may automatically initiate the state transition process.

Alternatively, the network operator (the operating person of the operator) may manually cause the eNB 45 to initiate the state transition process.

In the state transition process, first, the isolated capablity E-UTRAN 80 transmits a notification message to the UE 10 (S606). Here, the I-MME 46 may transmit the notification message to the UE 10.

The notification message may be a message requesting the UE 10 to detach, a message requesting the UE 10 to initiate an attach procedure, a message notifying the UE 10 of the state of connection (the isolated E-UTRAN state A and/or the isolated E-UTRAN state B) to the core network 7 to which the eNB 45 desires to make a transition, and/or a message notifying the UE 10 of a list of the UEs currently located in the service area of the eNB 45. The notification message may be a message having the meaning of at least one of the above. Alternatively, these messages may be notified as individual messages.

Note that the notification message may include information elements identifying the state of connection to the core network.

Specifically, the notification message may include identification information indicating that the state of connection to the core network to which the eNB 45 and/or the isolated capablity E-UTRAN 80 desires to make a transition is the isolated E-UTRAN state A, include identification information indicating that the connection state is the isolated E-UTRAN state B, or include identification information indicating that the connection state is the isolated E-UTRAN state (the isolated E-UTRAN state A and the isolated E-UTRAN state B).

The isolated capablity E-UTRAN 80 may include the list of the UEs currently located within the service area of the eNB 45, in the notification message addressed to the UE 10. For example, when the UE 30 permitted to perform communication based on the isolated E-UTRAN function is connected to the core network 7 via the LTE access network in the normal state, the eNB 45 may store the information on the connection and include identification information identifying the UE 30 in the notification message transmitted to the UE 10 in S606. The eNB 45 may include the identification information on the UE 30 in the notification message on the basis of whether the UE 30 belongs to the same group as the UE 10.

Note that the notification message may be a detach request message (non-access stratum: layer 3) transmitted from an MME to a UE in a known technique.

Furthermore, the isolated capablity E-UTRAN 80 may transmit, to the UE 10, the message including a detach request message including a cause value indicating the necessity of attach.

In this case, the I-MME 46 has, as some of the functions of the MME, the function of storing the MME context of the UE 10, the function of enabling transmission and reception of a non-access-stratum control message, and the function of transmitting, instead of the MME 40, the detach request message to the UE 10.

Alternatively, when the notification message in S606 is transmitted from the eNB 45, the notification message may be a layer-2 level message and request the UE 10 to release radio resources by deleting, from the UE 10, information that is included in the UE context and indicates that the UE 10 has been connected to the core network 7.

For example, the eNB 45 includes, in the notification message, application identification information identifying an application permitted to perform communication based on the isolated E-UTRAN function, and transmits the notification message to the UE 10.

Here, the application identification information may be identification information managed by a certain application server or may be identification information managed by the eNB 45. The eNB 45 makes a request for the release of the radio resources established for the application identified by the application identification information, with the notification message.

Alternatively, the eNB 45 transmits, to the UE 10, a radio bearer ID identifying a bearer with the radio bearer ID included in the notification message. The eNB 45 make a request for the deletion of information on the radio bearer ID, with the notification message.

The layer-2 level notification message transmitted from the eNB 45 to the UE 10 may be a radio resource control (RRC) connection re-establishment mess age.

Specifically, the layer-2 level notification message transmitted from the eNB 45 to the UE 10 may be a control message for an RRC connection. More specifically, the notification message may be a radio resource block establishment message, a radio resource change message, or a radio resource block release message.

Furthermore, the eNB 45 may transmit, to the UE 10, a notification message including a cause value indicating the necessity of attach.

In this case, the eNB 45 may have some of the MME functions. Specifically, the eNB 45 has the function of storing the UE context.

The eNB 45 may determine, instead of the MME 40, transmission of the radio resource block establishment message, the radio resource change message, or the radio resource block release message. For example, when the connection state between the eNB 45 and the UE 10 is an active state and/or a connected state, the eNB 45 may determine to transmit the radio resource block release message.

The isolated capablity E-UTRAN 80 may transmit, to the UE 10, notice information making a notification that the isolated capablity E-UTRAN 80 and/or the eNB 45 has initiated the process for a state transition to the isolated E-UTRAN state. The notice information may include a bearer ID specifying a bearer permitted to perform communication based on the isolated E-UTRAN function, TFT, or identification information on an application permitted to perform communication based on the isolated E-UTRAN function. Here, the isolated capablity E-UTRAN 80 may transmit the notice information as the notification message or transmit the information as an individual message different from the notification message.

The UE 10 receives the notification message from the isolated capablity E-UTRAN 80. When the notification message received by the UE 10 is a message requesting the UE 10 to initiate a detach or attach procedure, the UE 10 deletes the UE context or the bearer list from the storage 340 in response to the reception of the notification message (S608).

Furthermore, when the notification message received by the UE 10 from the isolated capablity E-UTRAN 80 is a layer-2 level message, the UE 10 releases the specified radio resources. For example, when the message includes application identification information, the UE 10 releases the radio resources established for the identified application. When the message includes a radio bearer ID, the eNB 45 releases the radio resources allocated to the radio bearer ID.

By contrast, when the notification message received by the UE 10 from the isolated capablity E-UTRAN 80 is a layer-3 message including identification information on a PDN connection, the UE 10 deletes the UE context related to the specified PDN connection. Furthermore, the UE 10 may transmit a response message as a response to the notification message, to the isolated capablity E-UTRAN 80 (S610). The response message is a detach response message, which is a message making a notification of completion of detach.

The isolated capablity E-UTRAN 80 receives, from the UE 10, the response message as a response to the notification message.

When the isolated capablity E-UTRAN 80 has made a transition to the isolated E-UTRAN state B, the eNB 45 included in the isolated capablity E-UTRAN 80 may transfer, to the MME 40, the response message received from the UE 10. In response to the reception of the response message, the MME 40 may delete the identification information on the UE 10 from the storage. Alternatively, the MME 40 may start a timer and store the identification information until the timer expires, and then delete the identification information from the storage upon expiration of the timer, or the MME 40 may delete the identification information from the storage upon receipt of an attach request message in an isolated E-UTRAN attach procedure from the isolated capablity E-UTRAN 80.

As described above, the UE 10 transmits, to the isolated capable E-UTRAN 80, a response message notifying the isolated capable E-UTRAN 80 of completion of detach, the isolated capablity E-UTRAN 80 receives a response message from the UE 10, the MME 40 receives a response message from the UE 10, and/or the timer of the MME 40 expires, which triggers the isolated capable E-UTRAN 80 to make a transition to the isolated E-UTRAN state.

The above procedure causes the UE 10 to detect a state transition.

### 1.3.1.2. Modified Example of State Transition Detection Method

Description will be further given to a modified example of a method of causing the UE 10 to detect that the isolated capablity E-UTRAN 80 has made a transition from the normal state to the isolated E-UTRAN state.

In the present modified example, the UE 10 detects a state transition of the isolated capablity E-UTRAN 80 by receiving a control message from the MME 40.

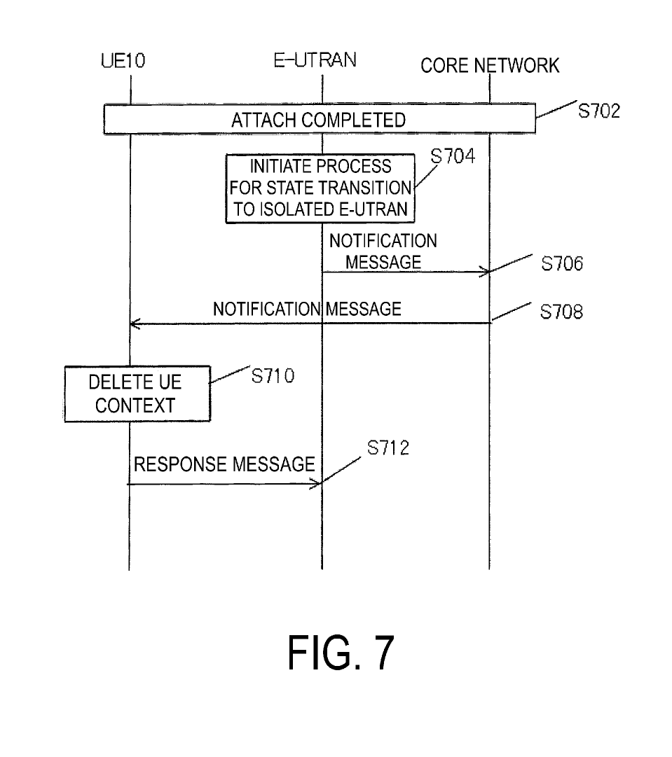

FIG. 7 illustrates an example of a state transition detection procedure by the UE 10. As illustrated in FIG. 6, in the initial state, the UE 10 has established a PDN connection with the core network 7 including the MME 40, via the isolated capablity E-UTRAN 80 (E-UTRAN) in the normal state (S702). In other words, the UE 10 has completed a known attach procedure.

The attach procedure (S702) in FIG. 7 and the attach procedure (S602) in FIG. 6 may be the same procedure. The initial condition in the present modified example is the same condition as that described in 1.3.1.1, and thus detailed description thereof is omitted.

In the attach procedure in the initial state, the I-MME 46 has acquired, from the MME 40, information necessary for communication based on the isolated E-UTRAN.

Next, a state transition process will be described. In the state transition process, first, the isolated capablity E-UTRAN 80 including the eNB 45 transmits a notification message to the core network 7 including the MME 40 (S706). In this operation, the notification message may be transmitted from the eNB 45 to the MME 40.

The notification message transmitted from the isolated capablity E-UTRAN 80 may be a message making a notification of the state of the connection to the core network 7 to which the eNB 45 and/or the isolated capablity E-UTRAN 80 desires to make a transition (the isolated E-UTRAN state B), and/or a message requesting the UE 10 to transmit a detach request message. The notification message may be a message having the meaning of at least one of the above. Alternatively, these messages may be notified as individual messages.

The core network 7 including the MME 40 receives the notification message from the isolated capablity E-UTRAN 80. The notification message includes at least identification information on the UE 10 located in the service area of the eNB 45 and permitted to perform communication based on the isolated E-UTRAN function. The notification message may further include identification information indicating that the eNB 45 has initiated a procedure for making a transition to the isolated E-UTRAN state B.

The isolated capablity E-UTRAN 80, the eNB 45, and/or the I-MME 46 may transmit, to the UE 10, notice information making a notification that the process for making a state transition to the isolated E-UTRAN state B has been initiated, separately from the notification message addressed to the core network 7. The notice information may include a bearer ID specifying a bearer permitted to perform communication based on the isolated E-UTRAN function, TFT, or identification information on an application permitted to perform communication based on the isolated E-UTRAN function.

In response to the reception of the notification message, the MME 40 transmits a notification message to the UE 10 (S708). The notification message may be a message requesting the UE 10 to detach, a message requesting the UE 10 to initiate an attach procedure, a message notifying the UE 10 of the state (the isolated E-UTRAN state B) of connection to the core network 7 to which the eNB 45 desires to make a transition, a message notifying the UE 10 of a list of UEs currently located in the service area of the eNB 45, a message requesting the UE 10 to initiate a TAU procedure, and/or request the UE 10 to initiate the TAU procedure. The notification message may be a message having the meaning of at least one of the above. Alternatively, these messages may be notified as individual messages.

Note that the notification message may include information elements identifying the state of connection to the core network.

Description will be given below of a case in which the notification message is a detach request message.

The MME 40 may include a cause value indicating the necessity of attach, in the detach request message addressed to the UE 10.

The MME 40 transmits the detach request message and thereafter transmits a detach connection request to the SGW 35, thereby causing a detach procedure to be performed in the core network.

The UE 10 receives the detach request message from the MME 40. The detach request message is a message requesting the UE 10 to initiate a detach and attach procedure. In response to the reception of the detach request message, the UE 10 deletes the UE context in the storage (S710).

Furthermore, in response to the reception of the detach request message, the UE 10 may delete the UE context. Furthermore, in response to the reception of the detach request message, the UE 10 may transmit a response message as a response to the notification message, to the isolated capablity E-UTRAN 80 (S712). The response message is a detach response message, which is a message making a notification of completion of detach.

The isolated capablity E-UTRAN 80 including the I-MME 40 receives the detach response message from the UE 10. In response to the reception of the detach response message, the MME 40 terminates the detach procedure.

Note that when the isolated capablity E-UTRAN 80 makes a transition to the isolated E-UTRAN state B, the MME 40 receives the detach response message from the UE 10 via the isolated capablity E-UTRAN 80.

Furthermore, the eNB 45 may delete, from the storage, identification information on the UE 10 in response to the detach procedure by the UE 10, reception of the response message from the UE 10, and/or reception of the response message. Alternatively, the eNB 45 may start a timer and store the identification information until the timer expires, and then delete the identification information from the storage upon expiration of the timer, or the eNB 45 may delete the identification information from the storage upon receipt of an attach request message from the UE 10.

As described above, the UE 10 transmits, to the isolated capable E-UTRAN 80, a response message notifying the isolated capable E-UTRAN 80 of completion of detach, the isolated capablity E-UTRAN 80 receives a response message from the UE 10, the MME 40 receives a response message from the UE 10, and/or the timer of the MME 40 expires, which triggers the isolated capable E-UTRAN 80 to make a transition to the isolated E-UTRAN state.

In the above method, the UE 10 may detect a state transition of the eNB 45 and/or the isolated capablity E-UTRAN 80.

### 1.3.2. Attach Procedure

In response to the detection of the state transition and/or the reception of a notification message from the network in 1.3.1, the UE 10 performs the isolated E-UTRAN attach procedure for establishing a PDN connection for communication based on the isolated E-UTRAN function.

In the present embodiment, the attach procedure for the isolated E-UTRAN is referred to as the isolated E-UTRAN attach procedure, to distinguish this attach procedure from an attach procedure for the isolated capablity E-UTRAN 80 in the normal state.

When the UE 10 initiates the isolated E-UTRAN attach procedure, the isolated capablity E-UTRAN 80 has made a transition to the isolated E-UTRAN state. The isolated capablity E-UTRAN 80 authenticates the UE 10 as a terminal permitted to perform communication based on the isolated E-UTRAN function in the isolated E-UTRAN state and establishes a PDN connection for communication based on the isolated E-UTRAN function.

Description will be given below of an example of the isolated E-UTRAN attach procedure.

### 1.3.2.1. Extension of IMSI

Description will be given below of an isolated E-UTRAN attach procedure using an IMSI identifying a terminal connectable to the isolated capablity E-UTRAN 80 and/or a terminal permitted to perform communication based on the isolated E-UTRAN function.

More specifically, an MCC and/or an MNC, both of which constituting an IMSI, may be a code allocated to a terminal device permitted to perform the isolated E-UTRAN function.

As described in 1.3.1.1, the eNB 45 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the eNB 45 may store the IMSI of such a terminal. Alternatively, the eNB 45 may store the terminal connectable to the isolated capablity E-UTRAN 80 and/or the MCC and/or the MNC permitted to perform communication based on the isolated E-UTRAN function, instead of the IMSI uniquely assigned to each terminal.

In response to the detection of a state transition in 1.3.1, the UE 10 transmits an attach request message to the isolated capablity E-UTRAN 80 (S802). The attach request message includes at least an IMSI. The attach request message may further include an APN, an Attach Type, and a PDN Type.

The IMSI may be an IMSI identifying the terminal connectable to the isolated capablity E-UTRAN 80 and/or the terminal permitted to perform communication based on the isolated E-UTRAN function. Note that the IMSI may be an IMSI including the terminal connectable to the isolated capablity E-UTRAN 80 and/or the MCC and/or the MNC permitted to perform communication based on the isolated E-UTRAN function.

Here, the UE 10 may store in advance the IMSI identifying the terminal connectable to the isolated capablity E-UTRAN 80 and/or the terminal permitted to perform communication based on the isolated E-UTRAN function as well as the terminal connectable to the isolated capablity E-UTRAN 80 and/or an IMSI not permitted to perform communication based on the isolated E-UTRAN function, and select any of the IMSIs in response to the detection of the isolated E-UTRAN state. Here, the UE 10 may select the IMSI identifying the terminal connectable to the isolated capablity E-UTRAN 80 and/or the terminal permitted to perform communication based on the isolated E-UTRAN function.

The Attach Type may include information for identifying the isolated E-UTRAN attach procedure.

The APN may be the same as the APN used in the attach procedure in the initial state.

When the UE 10 has not stored the IMSI for identifying the terminal permitted to perform communication based on the isolated E-UTRAN function, the UE 10 does not need to transmit an attach request.

The isolated capablity E-UTRAN 80 receives the attach request message from the UE 10. The eNB 45 included in the isolated capablity E-UTRAN 80 may receive the attach request message.

On the basis of the identification information on permission for communication based on the isolated E-UTRAN function in the storage, the eNB 45 performs an authentication procedure for authenticating the UE 10 that is a transmission source of the message as a terminal permitted to perform communication based on the isolated E-UTRAN function (S804).

In other words, when the MCC or the MNC, both of which constituting the IMSI included in the message received from the UE 10, is information identifying the terminal permitted to perform communication based on the isolated E-UTRAN function, the eNB 45 initiates the procedure for authenticating the isolated E-UTRAN attach request from the UE 10.

In the authentication process, the eNB 45 may select the I-MME 46. In a method of selecting the I-MME 46, the I-MME 46 may be determined, for example, on the basis of the physical distance to the eNB 45. Specifically, the eNB 45 may select the I-MME 46 closest to the eNB 45. Alternatively, the eNB 45 may hold in advance information on the MME to be selected in the isolated E-UTRAN state and select the I-MME 46 on the basis of the held information.

The eNB 45 transfers the attach request message to the selected I-MME 46. The I-MME 46 receives the attach request message from the eNB 45 and authenticates the UE 10 that is the transmission source of the message, as a terminal permitted to perform communication based on the isolated E-UTRAN function, on the basis of the identification information on permission for communication based on the isolated E-UTRAN function.

As described in 1.3.1.1, the I-MME 46 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the eNB 45 may store the IMSI of such a terminal. Alternatively, the eNB 45 may store the terminal connectable to the isolated capablity E-UTRAN 80 and/or the MCC and/or the MNC permitted to perform communication based on the isolated E-UTRAN function, instead of the IMSI uniquely assigned to each terminal.

Alternatively, the I-MME 46 may determine whether to authenticate the UE 10, on the basis of the MCC, the MNC, the TAC, the MME Group ID, and/or the MME code acquired in the method described in 1.3.1.1 and permitted to establish a connection to the isolated capablity E-UTRAN 80 and/or to perform communication based on the isolated E-UTRAN function.

More specifically, the I-MME 46 may determine not to authenticate the UE on the basis of the fact that the MCC and/or the MNC included in the IMSI transmitted by the UE 20 with the IMSI included in the attach request message or the TAU request message is the MCC and/or the MNC permitted to establish a connection to the isolated capablity E-UTRAN 80 and/or to perform communication based on the isolated E-UTRAN function.

As described above, the I-MME 46 may authenticate a connection to the isolated capablity E-UTRAN 80 and/or communication based on the isolated E-UTRAN function, for the terminal that has transmitted the attach request message, on the basis of the information acquired from the MME 40.

Furthermore, upon receipt of the attach request message, the I-MME 46 selects the LGW 47.

The I-MME 46 transmits a session establishment message to the selected LGW 47 to request the LGW 47 to store the management information on the UE 10.

The message may include the IMSI and the MSISDN of the UE 10, the TEID of the I-MME 46 for a control signal, the APN, the QoS, the PDN Type, the ME Identity, and the like.

The LGW 47 may update the management information on the UE 10 managed by the LGW 47, in response to the reception of the session establishment request message from the I-MME 46. The LGW 47 also allocate an IP address to the UE 10.

Subsequently, the LGW 47 transmits a session establishment response message to the I-MME 46. The response message may include the IP address of the UE 10, the IP address of the LGW, the TEID of the LGW, and the like.

The I-MME 46 transmits an attach accept message to the eNB 45 on the basis of the message received from the LGW 47. After the completion of the above-described procedure, the isolated capablity E-UTRAN 80 including the I-MME 46 transmits an attach accept message to the UE 10 (S806). The attach accept message may be a control message transmitted from the I-MME 46 to the UE 10 via the eNB 45.

Here, the attach accept message may be control information indicating that connection to the isolated capablity E-UTRAN 80 and/or communication based on the isolated E-UTRAN function has been authenticated. Alternatively, the attach accept message may be a message indicating that a PDN connection allowing for communication in the isolated E-UTRAN state has been established.

Here, the I-MME 47 may transmit the attach accept message to the UE 10 via the eNB 45 in response to the reception of the session establishment response message.

The attach accept message may include an APN, a GUTI, and a PDN address.

The APN may be an APN requested by the UE 10, or a newly assigned APN.

The GUTI is temporary identification information on the UE 10 allocated by the I-MME 46.

The PDN address is an IP address allocated to the UE 10 by the LGW 47. The PDN address may be the same as the IP address allocated to the UE 10 by the PGW during the attach procedure in the initial state.

Here, the I-MME 46 may include the IP address and the TEID of the LGW 47 in the attach accept message to be transmitted to the eNB 45. The eNB 45 acquires the IP address and the TEID of the LGW 47 included in the attach accept message and store the IP address and the TEID in the storage.

The attach accept message transmitted from the isolated capablity E-UTRAN 80 to the UE 10 may be a layer-2 RRC connection re-establishment message.

As in a known attach procedure, the UE 10 transmits, upon receipt of the attach accept message, an RRC reconfiguration complete message and an attach complete message to the isolated capablity E-UTRAN 80.

Through the above, the UE 10 permitted to perform communication based on the isolated E-UTRAN function completes the isolated E-UTRAN attach procedure with the IMSI.

### 1.3.2.2. Extension of IMEI

Description will be given below of an isolated E-UTRAN attach procedure using an IMEI identifying a terminal connectable to the isolated capablity E-UTRAN 80 and/or a terminal permitted to perform communication based on the isolated E-UTRAN function.

More specifically, the type allocation code (TAC) constituting part of the IMEI may be a code allocated to a terminal device permitted to perform the isolated E-UTRAN function.

As described in 1.3.1.1, the eNB 45 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the eNB 45 may store the IMEI of such a terminal. Alternatively, the eNB 45 may store the terminal connectable to the isolated capablity E-UTRAN 80 and/or the TAC permitted to perform communication based on the isolated E-UTRAN function, instead of the IMEI uniquely assigned to each terminal.

In response to the detection of a state transition in 1.3.1, the UE 10 transmits an attach request message to the isolated capablity E-UTRAN 80 (S802). The attach request message includes at least an IMEI.

The attach request message may further include an APN, an Attach Type, and a PDN Type.

The IMEI may be an IMEI identifying a terminal connectable to the isolated capablity E-UTRAN 80 and/or a terminal permitted to perform communication based on the isolated E-UTRAN function. Note that the IMEI may be an IMEI including a terminal connectable to the isolated capablity E-UTRAN 80 and/or the TAC permitted to perform communication based on the isolated E-UTRAN function.

Here, the UE 10 may store in advance the IMEI identifying the terminal connectable to the isolated capablity E-UTRAN 80 and/or the terminal permitted to perform communication based on the isolated E-UTRAN function as well as the IMEI for the terminal connectable to the isolated capablity E-UTRAN 80 and/or not permitted to perform communication based on the isolated E-UTRAN function, and select any of the IMEIs in response to the detection of the isolated E-UTRAN state. Here, the UE 10 may select the IMEI identifying the terminal connectable to the isolated capablity E-UTRAN 80 and/or the terminal permitted to perform communication based on the isolated E-UTRAN function.

The Attach Type may include information for identifying the isolated E-UTRAN attach procedure.

The APN may be the same as the APN used in the attach procedure in the initial state.

Note that when the UE 10 has not stored the IMEI for identifying the terminal permitted to perform communication based on the isolated E-UTRAN function, the UE 10 does not need to transmit an attach request.

The isolated capablity E-UTRAN 80 receives the attach request message from the UE 10. The eNB 45 included in the isolated capablity E-UTRAN 80 may receive the attach request message.

On the basis of the identification information on permission for communication based on the isolated E-UTRAN function in the storage, the eNB 45 performs an authentication process for authenticating the UE 10 that is the transmission source of the message as a terminal permitted to perform communication based on the isolated E-UTRAN function (S804).

In other words, when the TAC constituting part of the IMEI included in the message received from the UE 10 is information identifying the terminal permitted to perform communication based on the isolated E-UTRAN function, the eNB 45 initiates the procedure for authenticating the isolated E-UTRAN attach request transmitted from the UE 10.

On the basis of the authentication process, the eNB 45 may select the I-MME 46. In a method of selecting the I-MME 46, the I-MME 46 may be determined, for example, on the basis of the physical distance to the eNB 45. Specifically, the eNB 45 may select the I-MME 46 closest to the eNB 45. Alternatively, the eNB 45 may hold in advance information on the MME to be selected in the isolated E-UTRAN state and select the I-MME 46 on the basis of the held information.

The eNB 45 transfers the attach request message to the selected I-MME 46. The I-MME 46 receives the attach request message from the eNB 45 and authenticates the UE 10 that is the transmission source of the message, as a terminal permitted to perform communication based on the isolated E-UTRAN function, on the basis of the identification information on permission for communication based on the isolated E-UTRAN function.

As described in 1.3.1.1, the I-MME 46 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the I-MME 46 may store the IMEI of such a terminal. Alternatively, the I-MME 46 may store the terminal connectable to the isolated capablity E-UTRAN 80 and/or the TAC permitted to perform communication based on the isolated E-UTRAN function, instead of the IMEI uniquely assigned to each terminal.

Alternatively, the I-MME 46 may determine whether to authenticate the UE 10, on the basis of the TAC acquired in the method described in 1.3.1.1 and permitted to establish a connection to the isolated capablity E-UTRAN 80 and/or to perform communication based on the isolated E-UTRAN function.

More specifically, the I-MME 46 may determine the authentication on the basis of the fact that the TAC included in the IMSI transmitted by the UE 20 with the IMSI included in the attach request message is a TAC permitted to establish a connection to the isolated capablity E-UTRAN 80 and/or to perform communication based on the isolated E-UTRAN function.

As described above, the I-MME 46 may authenticate connection to the isolated capablity E-UTRAN 80 and/or communication based on the isolated E-UTRAN function, for the terminal that has transmitted the attach request message, on the basis of the information acquired from the MME 40.

Furthermore, upon receipt of the attach request message, the I-MME 46 selects the LGW 47.

The I-MME 46 transmits a session establishment message to the selected LGW 47 to request the LGW 47 to store the management information on the UE 10.

The message may include the IMSI and the MSISDN of the UE 10, the TEID of the I-MME 46 for a control signal, the APN, the QoS, the PDN Type, the ME Identity, and the like.

The LGW 47 may update the management information on the UE 10 managed by the LGW 47, in response to the reception of the session establishment request message from the I-MME 46. The LGW 47 also allocates an IP address to the UE 10.

Subsequently, the LGW 47 transmits a session establishment response message to the I-MME 46. The response message may include the IP address of the UE 10, the IP address of the LGW, the TEID of the LGW, and the like.

The I-MME 46 transmits an attach accept message to the eNB 45 on the basis of the message received from the LGW 47.

Here, the attach accept message may be control information indicating that the connection to the isolated capablity E-UTRAN 80 and/or the communication based on the isolated E-UTRAN function has been authenticated. Alternatively, the attach accept message may be a message indicating that a PDN connection allowing for communication in the isolated E-UTRAN state has been established.

After the completion of the above-described procedure, the isolated capablity E-UTRAN 80 including the I-MME 46 transmits an attach accept message to the UE 10 (S806). The attach accept message may be a control message transmitted from the I-MME 46 to the UE 10 via the eNB 45.

Here, the I-MME 47 may transmit the attach accept message to the UE 10 via the eNB 45 in response to the reception of the session establishment response message.

The attach accept message may include an APN, a GUTI, and a PDN address.

The APN may be an APN requested by the UE 10, or a newly assigned APN.

The GUTI is temporary identification information on the UE 10 allocated by the I-MME 46.

The PDN address is an IP address allocated to the UE 10 by the LGW 47. The PDN address may be the same as the IP address allocated to the UE 10 by the PGW during the attach procedure in the initial state.

Here, the I-MME 46 may include the IP address and the TEID of the LGW 47 in the attach accept message to be transmitted to the eNB 45. The eNB 45 acquires the IP address and the TEID of the LGW 47 included in the attach accept message and stores the IP address and the TEID in the storage.

The attach accept message transmitted from the isolated capablity E-UTRAN 80 to the UE 10 may be a layer-2 RRC connection re-establishment message.

As in a known attach procedure, the UE 10 transmits, upon receipt of the attach accept message, an RRC reconfiguration complete message and an attach complete message to the isolated capablity E-UTRAN 80.

Through the above, the UE 10 permitted to perform communication based on the isolated E-UTRAN function completes the isolated E-UTRAN attach procedure with the extended IMEI.

### 1.3.2.3. Extension of GUTI

Description will be given below of an isolated E-UTRAN attach procedure using a GUTI identifying a terminal connectable to the isolated capablity E-UTRAN 80 and/or a terminal permitted to perform communication based on the isolated E-UTRAN function.

More specifically, the GUTI may be identification information constituted of a specific value allocated to a terminal permitted to perform communication based on the isolated E-UTRAN function, or may be null.

Furthermore, the MCC, the MNC, the MME Group ID, and/or the MME code constituting part of the GUTI may be a specific code allocated to a terminal device permitted to perform the isolated E-UTRAN function. Alternatively, the GUTI may be null.

As described in 1.3.1.1, the eNB 45 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the eNB 45 may store the GUTI of such a terminal. Alternatively, the eNB 45 may store the terminal connectable to the isolated capability E-UTRAN 80 and/or the MCC, the MNC, the MME Group ID, and/or the MME code permitted to perform communication based on the isolated E-UTRAN function, instead of the GUTI uniquely assigned to each terminal.

In response to the detection of a state transition in 1.3.1, the UE 10 transmits an attach request message to the isolated capablity E-UTRAN 80 (S802). The attach request message includes at least a GUTI. The attach request message may further include an APN, an Attach Type, and a PDN Type.

The GUTI may be a GUTI identifying a terminal connectable to the isolated capablity E-UTRAN 80 and/or a terminal permitted to perform communication based on the isolated E-UTRAN function. Note that the GUTI may be a GUTI including the terminal connectable to the isolated capablity E-UTRAN 80 and/or the MCC, the MNC, the MME Group ID, and/or the MME code permitted to perform communication based on the isolated E-UTRAN function. Alternatively, the GUTI may be null.

Here, the UE 10 may store in advance the GUTI identifying the terminal connectable to the isolated capablity E-UTRAN 80 and/or the terminal permitted to perform communication based on the isolated E-UTRAN function as well as the GUTI that is for the terminal connectable to the isolated capablity E-UTRAN 80 and/or is not permitted to perform communication based on the isolated E-UTRAN function, and select any of the GUTIs in response to the detection of the isolated E-UTRAN state. Here, the UE 10 may select the GUTI identifying the terminal connectable to the isolated capablity E-UTRAN 80 and/or the terminal permitted to perform communication based on the isolated E-UTRAN function.

The Attach Type may include information for identifying the isolated E-UTRAN attach procedure.

The APN may be the same as the APN used in the attach procedure in the initial state.

Note that when the UE 10 does not store the GUTI for identifying the terminal permitted to perform communication based on the isolated E-UTRAN function, the UE 10 does not need to transmit an attach request.

The isolated capablity E-UTRAN 80 receives the attach request message from the UE 10. The eNB 45 included in the isolated capablity E-UTRAN 80 may receive the attach request message.

On the basis of the identification information on permission for communication based on the isolated E-UTRAN function in the storage, the eNB 45 performs an authentication process for authenticating the UE 10 that is the transmission source of the message as a terminal permitted to perform communication based on the isolated E-UTRAN function (S804).

In other words, when the MCC, the MNC, the MME Group ID, and/or the MME code constituting part of the GUTI included in the message received from the UE 10 is information identifying the terminal permitted to perform communication based on the isolated E-UTRAN function, or when the GUTI is null, the eNB 45 initiates the procedure for authenticating the isolated E-UTRAN attach request from the UE 10.

On the basis of the authentication process, the eNB 45 may select the I-MME 46. In a method of selecting the I-MME 46, the I-MME 46 may be determined, for example, on the basis of the physical distance to the eNB 45. Specifically, the eNB 45 may select the I-MME 46 closest from the eNB 45. Alternatively, the eNB 45 may hold in advance information on the MME to be selected in the isolated E-UTRAN state and select the I-MME 46 on the basis of the held information.

The eNB 45 transfers the attach request message to the selected I-MME 46. The I-MME 46 receives the attach request message from the eNB 45 and authenticates the UE 10 that is the transmission source of the message, as a terminal permitted to perform communication based on the isolated E-UTRAN function, on the basis of the identification information on permission for communication based on the isolated E-UTRAN function.

As described in 1.3.1.1, the I-MME 46 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the I-MME 46 may store the GUTI of such a terminal. Alternatively, the I-MME 46 may store the terminal connectable to the isolated capablity E-UTRAN 80 and/or the MCC, the MNC, the MME Group ID, and/or the MME code permitted to perform communication based on the isolated E-UTRAN function, instead of the GUTI uniquely assigned to each terminal.

Alternatively, the I-MME 46 may determine whether to authenticate the UE 10, on the basis of the MCC, the MNC, the MME Group ID, and/or the MME code acquired in the method described in 1.3.1.1 and permitted to establish a connection to the isolated capablity E-UTRAN 80 and/or to perform communication based on the isolated E-UTRAN function.

More specifically, the I-MME 46 may determine the authentication on the basis of the fact that the MCC, the MNC, the MME Group ID, and/or the MME code included in the GUTI transmitted from the UE 20 with the GUTI included in the attach request message is the MCC, the MNC, the MME Group ID, and/or the MME code permitted to establish a connection to the isolated capablity E-UTRAN 80 and/or to perform communication based on the isolated E-UTRAN function.

As described above, the I-MME 46 may authenticate connection to the isolated capablity E-UTRAN 80 and/or communication based on the isolated E-UTRAN function, for the terminal that has transmitted the attach request message, on the basis of the information acquired from the MME 40.

Furthermore, upon receipt of the attach request message, the I-MME 46 selects the LGW 47.

The I-MME 46 transmits a session establishment message to the selected LGW 47 to request the LGW 47 to store the management information on the UE 10.

The message may include the IMSI and the MSISDN of the UE 10, the TEID of the I-MME 46 for a control signal, the APN, the QoS, the PDN Type, the ME Identity, and the like.

The LGW 47 may update the management information on the UE 10 managed by the LGW 47, in response to the reception of the session establishment request message from the I-MME 46. The LGW 47 also allocates an IP address to the UE 10.

Subsequently, the LGW 47 transmits a session establishment response message to the I-MME 46. The response message may include the IP address of the UE 10, the IP address of the LGW, the TEID of the LGW, and the like.

The I-MME 46 transmits an attach accept message to the eNB 45 on the basis of the message received from the LGW 47.

Here, the attach accept message may be control information indicating that connection to the isolated capablity E-UTRAN 80 and/or communication based on the isolated E-UTRAN function has been authenticated. Alternatively, the attach accept message may be a message indicating that a PDN connection allowing for communication in the isolated E-UTRAN state has been established.

After the completion of the above-described procedure, the isolated capablity E-UTRAN 80 including the I-MME 46 transmits an attach accept message to the UE 10 (S806). The attach accept message may be a control message transmitted from the I-MME 46 to the UE 10 via the eNB 45.

Here, the I-MME 47 may transmit an attach accept message to the UE 10 via the eNB 45 in response to the reception of the session establishment response message.

The attach accept message may include an APN, a GUTI, and a PDN address.

The APN may be an APN requested by the UE 10, or a newly assigned APN.

The GUTI is temporary identification information on the UE 10 allocated by the I-MME 46.

The PDN address is an IP address allocated to the UE 10 by the LGW 47. The PDN address may be the same as the IP address allocated to the UE 10 by the PGW during the attach procedure in the initial state.

Here, the I-MME 46 may include the IP address and the TEID of the LGW 47 in the attach accept message to be transmitted to the eNB 45. The eNB 45 acquires the IP address and the TEID of the LGW 47 included in the attach accept message and stores the IP address and the TEID in the storage.

The attach accept message transmitted from the isolated capablity E-UTRAN 80 to the UE 10 may be a layer-2 RRC connection re-establishment message.

As in a known attach procedure, the UE 10 transmits, upon receipt of the attach accept message, an RRC reconfiguration complete message and an attach complete message to the isolated capablity E-UTRAN 80.

Through the above, the UE 10 permitted to perform communication based on the isolated E-UTRAN function completes the isolated E-UTRAN attach procedure with the extended GUTI.

### 1.3.3. TAU Procedure

As described in 1.3.1, the UE 10 receives a notification message from the isolated capablity E-UTRAN 80 or the core network 7.

When the notification message is a message requesting to initiate a TAU procedure, the UE 10 initiates the TAU procedure upon receipt of the message.

As described in 1.3.1.1, the eNB 45 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the eNB 45 may store the GUTI of such a terminal. Alternatively, the eNB 45 may store the terminal connectable to the isolated capability E-UTRAN 80 and/or the MCC, the MNC, the MME Group ID, and/or the MME code permitted to perform communication based on the isolated E-UTRAN function, instead of the GUTI uniquely assigned to each terminal.

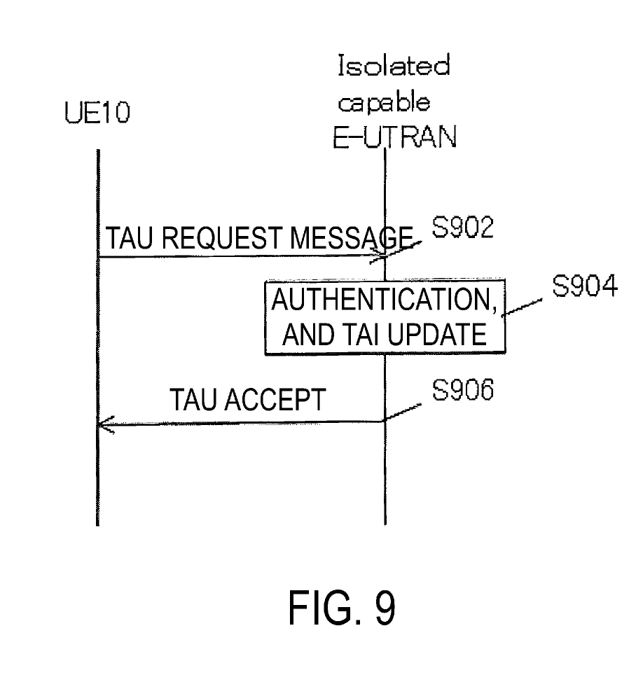

Description will be given below of an isolated E-UTRAN TAU procedure of the UE 10 connected to the isolated capablity E-UTRAN 80 in the isolated E-UTRAN state, with reference to FIG. 9.

Upon acquisition of the notification message or move to another TA, the UE 10 transmits a TAU request message to the isolated capablity E-UTRAN 80 including the eNB 45 (S902). The UE 10 may transmit the TAU request message to the eNB 45.

The TAU request message includes at least a GUTI.

The GUTI may be a GUTI identifying a terminal connectable to the isolated capablity E-UTRAN 80 and/or a terminal permitted to perform communication based on the isolated E-UTRAN function. Alternatively, the GUTI may be a GUTI including the terminal connectable to the isolated capablity E-UTRAN 80 and/or the MCC, the MNC, the MME Group ID, and/or the MME code permitted to perform communication based on the isolated E-UTRAN function. Alternatively, the GUTI may be null.

Here, the UE 10 may store the GUTI identifying the terminal connectable to the isolated capablity E-UTRAN 80 and/or the terminal permitted to perform communication based on the isolated E-UTRAN function as well as the GUTI that is for the terminal connectable to the isolated capability E-UTRAN 80 and/or is not permitted to perform communication based on the isolated E-UTRAN function, and select any of the GUTIs in response to the detection of the isolated E-UTRAN state. Here, the UE 10 may select the GUTI identifying the terminal connectable to the isolated capablity E-UTRAN 80 and/or the terminal permitted to perform communication based on the isolated E-UTRAN function. Note that when the UE 10 does not store the GUTI for identifying the terminal permitted to perform communication based on the isolated E-UTRAN function, the UE 10 does not need to transmit any TAU request.

The isolated capablity E-UTRAN 80 including the eNB 45 acquires the TAU request message including a specific GUTI.

On the basis of the GUTI included in the TAU request message acquired from the UE 10 and the identification information on permission for communication based on the isolated E-UTRAN function, the eNB 45 performs an authentication procedure for authenticating that the UE 10 performs TAU in the isolated E-UTRAN state (S904).

Specifically, on the basis of the fact that the MCC, the MNC, the MME Group ID, and/or the MME code included in the GUTI is a specific code assigned to the terminal device permitted the isolated E-UTRAN function, the eNB 45 may initiate a procedure for authenticating the UE 10.

Alternatively, on the basis of the GUTI being null, the eNB 45 may initiate a procedure for authenticating the UE 10 as a terminal permitted to perform communication based on the isolated E-UTRAN function.

The eNB 45 transfers the TAU request message to the I-MME 46. In response to the reception of the TAU request message, the I-MME 46 authenticates the UE 10 that is the transmission source of the message, as a terminal permitted to perform communication based on the isolated E-UTRAN function, on the basis of the identification information on permission for communication based on the isolated E-UTRAN function.

As described in 1.3.1.1, the I-MME 46 may acquire, in the normal state, information on the terminal connectable to the isolated capablity E-UTRAN 80 and/or the terminal permitted to perform communication based on the isolated E-UTRAN function from the core network 7, and store the information in the storage in advance. More specifically, the I-MME 46 may store the GUTI of such a terminal. Alternatively, the I-MME 46 may store the terminal connectable to the isolated capablity E-UTRAN 80 and/or the MCC, the MNC, the MME Group ID, and/or the MME code permitted to perform communication based on the isolated E-UTRAN function, instead of the GUTI uniquely assigned to each terminal.

As described above, the I-MME 46 may authenticate connection to the isolated capablity E-UTRAN 80 and/or communication based on the isolated E-UTRAN function, for the terminal that has transmitted the attach request message, on the basis of the information acquired from the MME 40.

Alternatively, the I-MME 46 may determine whether to authenticate the UE 10, on the basis of the MCC, the MNC, the MME Group ID, and/or the MME code acquired in the method described in 1.3.1.1 and permitted to establish a connection to the isolated capablity E-UTRAN 80 and/or to perform communication based on the isolated E-UTRAN function.

More specifically, the I-MME 46 may determine the authentication on the basis of the fact that the MCC, the MNC, the MME Group ID, and/or the MME code included in the GUTI transmitted from the UE 20 with the GUTI included in the TAU request message is the MCC, the MNC, the MME Group ID, and/or the MME code permitted to establish a connection to the isolated capablity E-UTRAN 80 and/or to perform communication based on the isolated E-UTRAN function.

Upon authentication of the UE 10, the I-MME 46 updates the TAI of the UE 10 (S904).

The isolated capablity E-UTRAN 80 including the eNB 45 and the I-MME 46 transmits a TAU accept message to the UE 10 (S906).

The TAU accept message is a response to the TAU request message and may include a GUTI and a TAI list.

Here, the TAU accept message may be control information indicating that connection to the isolated capablity E-UTRAN 80 and/or communication based on the isolated E-UTRAN function has been authenticated and the tracking area has been updated. Through the above procedure, the eNB 45 can authenticate the UE 10 performing the TAU procedure with the isolated capablity E-UTRAN 80 in the isolated E-UTRAN state, with the extended GUTI.

### 1.3.4. Reject Procedure

In 1.3.2. and 1.3.3., description has been given of the procedure in a case where the terminal device UE 10 permitted to perform communication based on the isolated E-UTRAN function transmits an attach request message or a TAU request message to the isolated capablity E-UTRAN 80.

Description will be given below of a reject procedure in a case where the UE 20 not permitted to perform communication based on the isolated E-UTRAN function has transmitted an attach request message or a TAU request message to the eNB 45.

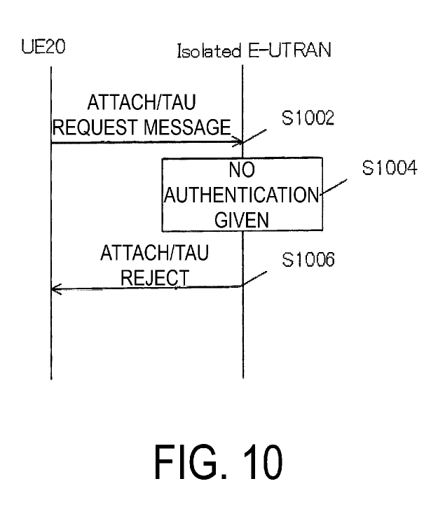

FIG. 10 is a diagram illustrating the reject procedure.

The UE 20 transmits an attach request message or a TAU request message to the eNB 45 included in the isolated capablity E-UTRAN 80 that has made a transition to the isolated E-UTRAN state (S1002).

The UE 10 may transmit the attach request message or the TAU request message to the isolated capablity E-UTRAN 80 in the same method as that described regarding the procedures in 1.3.2. and 1.3.3. Hence, detailed description thereof is omitted.

As described above, the UE 20 is a terminal not permitted to perform communication based on the isolated E-UTRAN function. Accordingly, the eNB 45 determines not to authenticate the UE 20 on the basis of the UE identification information included in the attach request message or the TAU request message (S1004).

Here, in the authentication process, the eNB 45 may determine not to permit connection to the isolated capablity E-UTRAN 80 and/or communication based on the isolated E-UTRAN function.

More specifically, the I-MME 46 may determine not to authenticate the UE 20 on the basis of the IMSI, the IMEI, or the GUTI transmitted from the UE 20.

More specifically, the I-MME 46 may determine not to authenticate the UE 20, on the basis of the IMSI, the IMEI, or the GUTI acquired in the method described in 1.3.1.1 and permitted to establish a connection to the isolated capablity E-UTRAN 80 and/or to perform communication based on the isolated E-UTRAN function. More specifically, the I-MME 46 may determine not to authenticate the UE 20 on the basis of the fact that the IMSI, the IMEI, or the GUTI transmitted by the UE 20 with being included in the attach request message or the TAU request message is not the IMSI permitted to establish a connection to the isolated capablity E-UTRAN 80 and/or to perform communication based on the isolated E-UTRAN function.

Alternatively, the I-MME 46 may determine not to authenticate the UE 20, on the basis of the MCC and/or the MNC acquired in the method described in 1.3.1.1 and permitted to establish a connection to the isolated capablity E-UTRAN 80 and/or to perform communication based on the isolated E-UTRAN function.

More specifically, the I-MME 46 may determine not to authenticate the UE 20 on the basis of the fact that the MCC and/or the MNC included in the IMSI transmitted by the UE 20 with the IMSI included in the attach request message not being the MCC and/or the MNC permitted to establish a connection to the isolated capablity E-UTRAN 80 and/or to perform communication based on the isolated E-UTRAN function.

Alternatively, the I-MME 46 may determine not to authenticate the UE 20, on the basis of the TAC acquired in the method described in 1.3.1.1 and permitted to establish a connection to the isolated capablity E-UTRAN 80 and/or to perform communication based on the isolated E-UTRAN function. More specifically, the I-MME 46 may determine not to authenticate the UE 20 on the basis of the fact that the TAC included in the IMSI transmitted by the UE 20 with the IMSI included in the attach request message is not the TAC permitted to establish a connection to the isolated capablity E-UTRAN 80 and/or to perform communication based on the isolated E-UTRAN function.

Alternatively, the I-MME 46 may determine not to authenticate the UE 20, on the basis of the MCC, the MNC, the MME Group ID, and/or the MME code acquired in the method described in 1.3.1.1 and permitted to establish a connection to the isolated capablity E-UTRAN 80 and/or to perform communication based on the isolated E-UTRAN function. More specifically, the I-MME 46 may determine not to authenticate the UE 20 on the basis of the fact that the MCC, the MNC, the MME Group ID, and/or the MME code included in the GUTI transmitted by the UE 20 with the GUTI included in the attach request message or the TAU request message is not the MCC, the MNC, the MME Group ID, and/or the MME code permitted to establish a connection to the isolated capablity E-UTRAN 80 and/or to perform communication based on the isolated E-UTRAN function.

Alternatively, the I-MME 46 may determine not to authenticate the UE 20, on the basis of the GUTI acquired in the method described in 1.3.1.1 and permitted to establish a connection to the isolated capablity E-UTRAN 80 and/or to perform communication based on the isolated E-UTRAN function. More specifically, the I-MME 46 may determine not to authenticate the UE 20 on the basis of the fact that the GUTI transmitted by the UE 20 with the GUTI included in the attach request message or the TAU request message is not null indicating permission for connection to the isolated capablity E-UTRAN 80 and/or communication based on the isolated E-UTRAN function. Here, the GUTI being null may refer to the information element in the GUTI being zero or void.

The isolated capablity E-UTRAN 80 transmits, to the UE 20, a reject message as a response to the request message (S1006).

When the message received by the isolated capablity E-UTRAN 80 is an attach request message, the isolated capablity E-UTRAN 80 transmits the attach reject message to the UE 20.

More specifically, the I-MME 46 may transmit the attach reject message to the eNB 45, and the eNB 45 may transmit the received attach reject message to the UE 20. Thus, the I-MME 46 may transmit the attach reject message to the UE 20 via the eNB 45. Alternatively, the I-MME 46 may transmit the attach reject message directly to the UE 20.

Alternatively, when the message received by the isolated capablity E-UTRAN 80 is a TAU request message, the isolated capablity E-UTRAN 80 transmits a TAU reject message to the UE 20.

More specifically, the I-MME 46 may transmit the TAU reject message to the eNB 45, and the eNB 45 may transmit the received TAU reject message to the UE 20. Thus, the I-MME 46 may transmit the attach reject message to the UE 20 via the eNB 45. Alternatively, the I-MME 46 may transmit the TAU reject message directly to the UE 20.

The attach reject message and the TAU reject message include a cause value and identification information indicating that the message is a reject message. Here, the cause value may be information indicating the cause of the rejection. For example, the cause value may be an already defined cause. For example, the cause value may be IMEI not accepted, EPS services not allowed, EPS services and non-EPS services not allowed, UE identity cannot be derived by the network, PLMN not allowed, Tracking Area not allowed, EPS services not allowed in this PLMN, MSC temporarily not reachable, Network failure, CS domain not available, UE security capabilities mismatch, or Severe network failure.

Alternatively, the cause value may indicate that the access network is in the isolated E-UTRAN state or may be information indicating that the terminal transmitting the attach request message or the TAU request message is unable to connect to the isolated capablity E-UTRAN 80.

The UE 20 acquires the reject message from the isolated capablity E-UTRAN 80 and then confirms that the isolated capablity E-UTRAN 80 is in the isolated E-UTRAN state to stop transmitting messages requiring connectivity to the core network, such as an attach request message and a TAU request message, to the isolated capablity E-UTRAN 80.

Hence, the UE 20 may detect the isolated E-UTRAN state, in response to the reception of a reject notification message, such as an attach reject message or a TAU reject message, and/or on the basis of cause information included in the reject notification message.

Additionally or alternatively, the UE 20 may stop retransmission of an attach request message or a TAU request message, in response to the reception of a reject notification message, such as an attach reject message or a TAU reject message, and/or on the basis of cause information included in the reject notification message.

Additionally or alternatively, the UE 20 may make a transition to a state in which transmission of an attach request message or a TAU request message is prohibited, in response to the reception of a reject notification message, such as an attach reject message or a TAU reject message, and/or on the basis of cause information included in the reject notification message.

Through the above, the request message from the UE 20 not permitted to perform communication based on the isolated E-UTRAN function is rejected by the isolated capablity E-UTRAN 80. This configuration allows the isolated capablity E-UTRAN 80 to permit or reject a connection depending on the terminal in an emergency state. Furthermore, the terminal connecting to the isolated E-UTRAN 80 can communicate with another terminal connecting to the isolate E-UTRAN 80 via the isolate E-UTRAN 80.

### 2. Modified Example

Additionally, the programs run on the devices in the embodiments are programs that control a CPU (programs that cause a computer to function) so as to realize the functions of the above-described embodiments. The information handled by these devices is temporarily held in a transitory storage device (RAM, for example) at the time of processing, and is then stored in various storage devices such as a ROM and an HDD, read out by the CPU as necessary, and edited and written.

Here, a semiconductor medium (a ROM, a non-volatile memory card, or the like, for example), an optical recording medium/magneto-optical recording medium (a digital versatile disc (DVD), a magneto optical disc (MO), a mini disc (MD), a compact disc (CD), a BD, or the like, for example), a magnetic recording medium (magnetic tape, a flexible disk, or the like, for example), and the like can be given as examples of recording media for storing the programs. In addition to realizing the functions of the above-described embodiments by executing programs that have been loaded, there are also cases where the functions of the present invention are realized by the programs running cooperatively with an operating system, other application programs, or the like on the basis of instructions included in those programs.

When delivering these programs to the market, the programs can be stored in a portable recording medium, or transferred to a server computer connected via a network such as the Internet. In this case, the storage device serving as the server computer is of course also included in the present invention.

Additionally, each device in the above-described embodiments may be partially or completely realized as large scale integration (LSI) circuit, which is a typical integrated circuit. The functional blocks of each device may be individually realized as chips, or may be partially or completely integrated into a chip. Furthermore, a circuit integration technique is not limited to the LSI, and the integrated circuit may be realized with a dedicated circuit or a general-purpose processor. Furthermore, if advances in semiconductor technology produce circuit integration technology capable of replacing LSI, it is of course possible to use integrated circuits based on the technology.

Additionally, although the above-described embodiments mention the LTE and a WLAN (IEEE 802.11a/b/n and the like, for example) as examples of the wireless access network, the connections may be made with WiMAX instead of a WLAN.

### REFERENCE SIGNS LIST

1 Communication system
2 Backhaul
7 Core network
9 PDN
10 UE
20 UE
30 PGW
35 SGW
40 MME
45 eNB
46 I-MME
47 LGW
50 HSS
55 AAA
60 PCRF
65 ePDG
70 WLAN ANa
75 WLAN ANb
80 Isolated capablity E-UTRAN

1. A base station device configured to:
transmit, to a terminal device, a notification message indicating that the base station device is in a first state where connectivity to a core network is lost and/or a second state where a restriction on connectivity to the core network is imposed;
receive an attach request message from the terminal device;
when the attach request message includes permission information,
transmit an attach permission message to the terminal device as a response to the attach request message,
the permission information being permission information indicating that communication based on an isolated E-UTRAN function is permitted,
the isolated E-UTRAN function being a function of the base station device or a gateway transferring user data when the base station device is in the first state where connectivity to the core network is lost and/or the second state where the restriction on connectivity to the core network is imposed; and
when the attach request message does not include the permission information,
transmit an attach reject message to the terminal device as a response to the attach request message.

2. The base station device according to claim 1, configured to transmit the attach reject message including at least cause information indicating that establishing a connection to an isolated E-UTRAN is not permitted.

3. The base station device according to claim 1, wherein
the permission information is a mobile country code (MCC) and/or a mobile network code (MNC) that is included in an international mobile subscriber identity (IMSI) unique to the terminal device and indicates that communication based on the isolated E-UTRAN is permitted.

4. The base station device according to claim 1, wherein
the permission information is a type allocation code (TAC) that is included in an international mobile subscriber identity (IMSI) unique to the terminal device and indicates that communication based on the isolated E-UTRAN is permitted.

5. The base station device according to claim 1, wherein
the permission information is a global unique MME identity (GUMMEI) that is included in a global unique temporary UE identity (GUTI) identifying the terminal device and indicates that communication based on the isolated E-UTRAN is permitted.

6. The base station device according to claim 5, wherein
the GUMMEI is null.

7. A terminal device configured to:
transmit an attach request message to a base station device; and
receive an attach reject message that is a response to the attach request message and includes at least cause information indicating that establishing a connection to an isolated E-UTRAN is not permitted, the isolated E-UTRAN being an access network having the base station device in a first state where connectivity to a core network is lost and/or a second state where a restriction on connectivity to the core network is imposed.

8. A terminal device having a first packet data network (PDN) connection established with a core network, an isolated E-UTRAN function being a function of a base station device or a gateway transferring user data when the base station device is in a first state where connectivity to the core network is lost and/or a second state where a restriction on connectivity to the core network is imposed,
the terminal device being configured to:
receive, from the base station device, a notification message indicating that the base station device is in the first state and/or the second state;
detach the first PDN connection on the basis of the notification message;
when permission information indicating that communication based on the isolated E-UTRAN function is permitted is stored,
initiate an attach procedure by transmitting, to the base station device, an attach request message including at least the permission information; and
when permission information indicating that communication based on the isolated E-UTRAN function is permitted is not stored,
not initiate the attach procedure.

9. The terminal device according to claim 8, wherein
the permission information is a mobile country code (MCC) and/or a mobile network code (MNC) that is included in an international mobile subscriber identity (IMSI) unique to the terminal device and indicates that communication based on the isolated E-UTRAN is permitted.

10. The terminal device according to claim 8, wherein
the permission information is a type allocation code (TAC) that is included in an international mobile subscriber identity (IMSI) unique to the terminal device and indicates that communication based on the isolated E-UTRAN is permitted.

11. The terminal device according to claim 8, wherein
the permission information is a global unique MME identity (GUMMEI) that is included in a global unique temporary UE identity (GUTI) identifying the terminal device and indicates that communication based on the isolated E-UTRAN is permitted.

12. The terminal device according to claim 11, wherein
the GUMMEI is null.

13. A communication control method for a base station device, comprising the steps of:
transmitting, to a terminal device, a notification message indicating that the base station device is in a first state where connectivity to a core network is lost and/or a second state where a restriction on connectivity to the core network is imposed;
receiving an attach request message from the terminal device;
when the attach request message includes permission information,
transmitting an attach permission message to the terminal device as a response to the attach request message, the permission information being permission information indicating that communication based on an isolated E-UTRAN function is permitted,
the isolated E-UTRAN function being a function of the base station device or a gateway transferring user data when the base station device is in the first state where connectivity to the core network is lost and/or the second state where a restriction on connectivity to the core network is imposed; and
when the attach request message does not include the permission information,
transmitting an attach reject message to the terminal device as a response to the attach request message.

14. The communication control method for a base station device according to claim 13, the method comprising the step of:
including, in the attach reject message, at least cause information indicating that establishing a connection to an isolated E-UTRAN is not permitted.

15. The communication control method for a base station device according to claim 13, wherein
the permission information is a mobile country code (MCC) and/or a mobile network cod (MNC) that is included in an international mobile subscriber identity (IMSI) unique to the terminal device and indicates that communication based on the isolated E-UTRAN is permitted.

16. The communication control method for a base station device according to claim 13, wherein
the permission information is a type allocation code (TAC) that is included in an international mobile subscriber identity (IMSI) unique to the terminal device and indicates that communication based on the isolated E-UTRAN is permitted.

17. The communication control method for a base station device according to claim 13, wherein
the permission information is a global unique MME identity (GUMMEI) that is included in a global unique temporary UE identity (GUTI) identifying the terminal device and indicates that communication based on the isolated E-UTRAN is permitted.

18. The communication control method for a base station device according to claim 17, wherein
the GUMMEI is null.

19. A communication control method for a terminal device, comprising the steps of:
transmitting an attach request message to a base station device; and
receiving an attach reject message that is a response to the attach request message and includes at least cause information indicating that establishing a connection to an isolated E-UTRAN is not permitted,
the isolated E-UTRAN being an access network having the base station device in a first state where connectivity to a core network is lost and/or a second state where a restriction on connectivity to the core network is imposed.

20. A communication control method for a terminal device, comprising the steps of:
establishing a first packet data network (PDN) connection with a core network to allow the terminal device to communicate, an isolated E-UTRAN function being a function of a base station device or a gateway transferring user data when the base station device is in a first state where connectivity to the core network is lost and/or a second state where a restriction on connectivity to the core network is imposed,
receiving, from the base station device, a notification message indicating that the base station device is in the first state and/or the second state;
detach the first PDN connection on the basis of the notification message; and
only when at least permission information indicating that communication based on the isolated E-UTRAN function is permitted is stored,
initiating an attach procedure by transmitting, to the base station device, an attach request message including at least the permission information.

21. The communication control method for a terminal device according to claim 20, wherein
the permission information is a mobile country code (MCC) and/or a mobile network cod (MNC) that is included in an international mobile subscriber identity (IMSI) unique to the terminal device and indicates that communication based on the isolated E-UTRAN is permitted.

22. The communication control method for a terminal device according to claim 20, wherein
the permission information is a type allocation code (TAC) that is included in an international mobile subscriber identity (IMSI) unique to the terminal device and indicates that communication based on the isolated E-UTRAN is permitted.

23. The communication control method for a terminal device according to claim 20, wherein
the permission information is a global unique MME identity (GUMMEI) that is included in a global unique temporary UE identity (GUTI) identifying the terminal and indicates that communication based on the isolated E-UTRAN is permitted.

24. The communication control method for a terminal device according to claim 23, wherein
the GUMMEI is null.
